(19) United States
(12) Patent Application Publication
(10) Pub. No.: US 2025/0154026 A1
(43) Pub. Date: May 15, 2025

(54) MODULAR SYSTEM FOR SEPARATING WATER FROM AQUEOUS SOLUTIONS

(71) Applicant: Carnot LLC, Sacramento, CA (US)

(72) Inventors: Matthew Clements, Sacramento, CA (US); Michael Izenson, Sacramento, CA (US); Daniel Kromer, Sacramento, CA (US); William Shaw, Sacramento, CA (US); John Tonner, Sacramento, CA (US)

(21) Appl. No.: 18/946,841

(22) Filed: Nov. 13, 2024

Related U.S. Application Data
(60) Provisional application No. 63/674,772, filed on Jul. 23, 2024.
(60) Provisional application No. 63/598,896, filed on Nov. 14, 2023.

(51) Int. Cl. C02F 1/04; C02F 1/06; C02F 103/08

(52) U.S. Cl. CPC C02F 1/048; C02F 1/06; C02F 2103/08; C02F 2209/006

(57) ABSTRACT

A brine concentration system may include a closed-cycle heat pump, a brine heater configured to heat brine, a flash tank to evaporate a portion of heated brine to steam, and a steam condenser in which to condense the steam to distilled water. The system may include an electric vacuum pump in connection with the flash tank and the steam condenser. The electric vacuum pump may reduce a pressure within the flash tank and the steam condenser to reduce a boiling point of the brine. The system may include a controller that dynamically adjusts operations of the closed-cycle heat pump and/or the electric vacuum pump.

### CROSS-REFERENCE TO RELATED APPLICATIONS

The present application claims the benefit of U.S. Provisional Patent Application No. 63/598,896, filed on Nov. 14, 2023, and U.S. Provisional Patent Application No. 63/674,772, filed on Jul. 23, 2024, which are hereby incorporated by reference in their entirety.

### TECHNICAL FIELD

The present disclosure relates generally to distillation methods and systems for brine concentration at low temperatures and responsive to power conditions.

### BACKGROUND

Water stress due to climate change and over-pumping of groundwater is a severe problem in the United States and globally, posing disruption risk to municipalities, agriculture, and industrial operations. Disadvantaged communities often suffer most from lack of access to safe drinking water. Safe and equitable access to small-scale (e.g., less than 50 gpm), decentralized treatment of non-traditional sources—e.g., (1) seawater and ocean water; (2) brackish groundwater; (3) industrial wastewater; (4) municipal wastewater; (5) agricultural wastewater; (6) mining wastewater; (7) produced water; and (8) power and cooling wastewater—could help make up this shortfall, but is often uneconomical due to the cost of brine disposal because we do not have low-cost, zero-carbon, zero-liquid-discharge (“ZLD”) treatment trains.

For example, brackish groundwater represents a significant opportunity in the US. According to the US Geological Survey, the amount of brackish groundwater in the US is 800× greater than all current annual fresh groundwater use. However, brine disposal is a huge cost and schedule constraint. Electrodialysis Reversal (“EDR”) and Reverse Osmosis (“RO”) facilities may be restricted to lower recovery rates and/or lower volumes of EDR/RO concentrate to meet local disposal options. “Recovery rate” or “recovery ratio” refers to the ratio of the distillate product flow rate to the feed flow rate supplied. Because these facilities are likely to be inland, there is no nearby outfall or brine line in which to dispose of the brine. Injection wells require favorable geology or existing infrastructure, risk contamination of freshwater aquifers, and are increasingly unavailable due to regulation in response to seismic activity. Existing brine lines, such as the Inland Empire Brine Line, are capacity constrained and new brine lines are prohibitively expensive to build. Spray drying and evaporation ponds are feasible only where land is available and when climate and low winds permit. Trucking brine off-site is expensive due to both the cost of trucking the brine to a disposal facility and the tipping fees charged by disposal facilities, and creates additional risks and greenhouse gas (GHG) emissions.

To reduce the volume of RO/EDR concentrate that needs to be trucked and tipped, an evaporator can be used to concentrate the brine to higher concentrations. Optionally, a crystallizer can be used to reduce the concentrated brine to a slurry that can be centrifuged to a wetcake of less than 20% free moisture that is suitable for transport and disposal in a non-hazardous landfill. However, conventional evaporators and crystallizers are expensive to buy and to operate, and often rely on waste heat/steam from combustion processes. Thus, there is a need for a lower-cost, zero-carbon high recovery (“HR”) brine concentration system to make brine management more affordable, especially for small-scale, decentralized applications.

Obstacles to using conventional evaporators and crystallizers for small-scale, distributed applications include their high capital cost and high operating cost. A major contributor to the high capital cost of conventional evaporators and crystallizers is their operation at 100° C.-120° C. or higher, which precludes the use of low-cost materials like thermoplastics. Stress cracking corrosion and hydrolysis of the chloride salts which typically dominate these brine require the use of expensive noble alloys (e.g., titanium and high nickel-chrome-molybdenum alloys) to resist the extremely corrosive nature of these salts at high concentrations and temperatures.

High temperature operation is also the major contributor to high operating cost. Operation at 70° C. or higher may exacerbate scale formation where the solubility of certain sparingly soluble salts is exceeded, resulting in their precipitation as hard scale on heat-transfer surfaces. Scale formation is often mitigated by operating the plant at reduced recovery rates, by seed crystal nucleation control, or by adding chemical scale inhibitors. But low recovery defeats the purpose of a ZLD system; seed slurry scale control is labor-intensive and time-consuming at start-up and shut-down; and the use of chemical scale inhibitors requires a chemical supply chain, with its associated cost, logistics, and carbon footprint. For example, in wastewaters where calcium and silica salts are present even in relatively low concentrations, seeding is mandatory in conventional falling film brine concentrators. When calcium and magnesium salts predominate in a waste brine, chemical softening is used to remove most of the magnesium and calcium ions as precipitates of magnesium hydroxide and calcium carbonate, which settle in a clarifier and the resulting sludge is dewatered and disposed of in a landfill. Such schemes increase costs due to the additional equipment required to seed or soften the wastewater, the cost of seed or softening chemicals and additional pretreatment sludge disposal, and the additional complexity of the overall process. Moreover, the potential for local zones of concentrations that are higher than the bulk solution complicates this issue and means that scaling may occur even when the bulk solution is below salt saturation limits.

Another contribution to the high operating cost of conventional evaporators and crystallizers is the limitation resulting from the use of mechanical vapor compression's (“MVC”) use of the evaporated water vapor as the working fluid. Although the addition of heat to the evaporated water vapor using an electrically-driven vapor compressor improves efficiency by recycling the latent heat of vaporization, the amount of ΔT driving force which can be produced with commercially available and affordable compressors is limited. The increasing boiling point elevation (BPE) associated with increasing salinity cuts into the available ΔT output from the compressor, limiting the ultimate concentration of the brine that can be achieved. To concentrate the brine further, one must supply higher temperature steam from another heat source (e.g., fossil-fueled boiler). Economical compressors typically used in MVC evaporators can achieve about a 2.0 compression ratio at best, which means vapor evaporated at 100° C. can be heated via the compressor to approximately 120° C. thereby providing 20° C. AT for the process. Considering that 5° C. is a typical ΔT necessary for practical heat transfer, then 15° C. remains as the upper limit for BPE for a solution to be evaporated using an MVC evaporator. Since BPE is a colligative property of the brine this becomes an unavoidable upper limit for concentration; similar to a membrane cannot handle infinitely high osmotic pressures. Once the BPE reaches 15° C., it must be transferred from an MVC process to a steam-driven process to continue concentrating the solution by evaporation. Similar limits are reached for osmotic processes and is the primary reason the complexities of multi-stage or counter-flow is introduced in an attempt to increase the maximum salinity that can be handled by membrane processes.

Other obstacles to conventional MVC-based brine concentration in small-scale, distributed applications include being highly sensitive to brine chemistry variations; requirements for operator oversight; frequent maintenance due to scaling and corrosion; expensive and time-consuming maintenance to remove scale from tube bundles; and a limited recovery rate.

What is needed is a brine concentration system that can maximize recovery of freshwater, minimize brine disposal costs, and overcome the following problems:
Noble materials of construction are expensive
Fuel is expensive and combustion generates GHGs
Electricity is expensive during certain times of day
Relying on MVC limits the recovery ratio achievable from concentrated brines
Sensitivity to variations in the chemical composition of the brine
In falling film brine concentrators, evaporation occurs on the heat transfer surface, exacerbating scaling potential
High temperature evaporation (70-120° C.) increases rates of scaling and corrosion, requiring more frequent maintenance
High temperature operation requires energy input to increase the temperature of the process equipment; much of this energy investment can be lost during intermittent operation as the equipment naturally cools during down time. This effect reduces the efficiency of high-temperature thermal processes unless they can operate continuously
High temperature operation requires ramp up to operating temperature; not suited to intermittent operation
Fixed-speed compressors are limited in their ability to adapt to variable flow or power conditions
Inability to operate variably and intermittently prevents participation in demand response incentives
Operating a high capital cost asset at a low capacity factor requires capital to be uncommonly patient to recoup its investment
Locations may lack non-electrical infrastructure (e.g., steam, cooling water, compressed air)
Locations may make constant in-person operator oversight challenging or impossible
Locations may lack specialized labor to perform maintenance tasks
Locations may make it difficult to supply chemicals for ongoing operation
Large, bespoke brine concentrators and crystallizers are not mass-manufacturable to achieve economies of scale

Closed-cycle heat pump evaporators are known in the art as an alternative to MVC. For example, a process for crystallizing high solubility salts at low temperature and deep vacuum is described in U.S. Pat. No. 8,052,763 (the '763 patent), titled “Method for Removing Dissolved Solids from Aqueous Waste Streams.” The '763 patent describes a process for precipitating dissolved solids in a waste stream using an evaporation-crystallization system operated under low pressure and low temperature. The '763 patent describes the process as applicable to zero liquid discharge systems to treat wastewaters from leachate collecting systems, from wet scrubbing operations such as those used in flue gas desulfurization and coal gasification, or from fracking operations, without the use of clarification or chemical conditioning. The '763 patent describes using a closed-cycle heat pump to provide the heat required to evaporate the waste stream and the cooling required to condense the vapor in a steam condenser. According to the '763 patent, using a closed-cycle heat pump reduces the size of the compressor otherwise required for an open cycle MVC/MVR heat pump that uses steam as the working fluid, and also protects the compressor if foaming occurs in evaporator. According to the '763 patent, corrosivity was greatly reduced from that which would be experienced at temperatures found when operating at/near atmospheric pressure, which allows use of a wider variety of materials in the construction of the system. According to the '763 patent, in a preferred embodiment, there is no need for clarification or for addition of chemicals required in a conventional evaporation-crystallization processes.

### SUMMARY

The ultra-low-temperature distillation (ULTD) process and systems disclosed herein improve on prior shortcomings as follow:
Low capital costs. The proposed system mitigates the need for noble alloys by operating at ultra-low temperatures (<30° C.). At these temperatures, the flash tank can be stainless steel or thermoplastic, and the piping can be thermoplastic. The heat exchanger may optionally be thermoplastic. The system may use a commercial, off-the-shelf W2WHP to leverage the economies of scale and R&D investments in that industry.
Reduced GHG emissions. The proposed system mitigates GHG emissions by being fully-electric and by using a multi-stage heat pump and VFD-controlled vacuum pump and water pumps to operate flexibly/intermittently.
Low energy costs. The proposed system mitigates energy costs by being fully-electric and capable of operating flexibly/intermittently, and by operating the heat pump in a “low-lift” regime at which it achieves a very high coefficient of performance (“COP”). Low temperature operation is a key enabler because the system need not (1) waste time ramping up to high temperature after a shutdown; and (2) waste energy by reheating components that cooled off naturally during a shutdown.
High recovery ratio. The proposed system uses a closed-cycle heat pump to produce higher ΔT than an open-cycle vapor compressor to achieve higher recovery (up to ZLD) from waste brines using only electric power. A robust, forced circulation (flashing) evaporator design is employed to concentrate brines up to, and beyond, saturation, and maximize freshwater recovery with no scale on the heat transfer surface.
Low operating and maintenance costs. The proposed system mitigates the need for maintenance by (1) operating at ultra-low temperatures, at which rates of scaling are lower so fewer, if any, pretreatment chemicals are required; (2) using a robust, forced-circulation flash evaporator design so that evaporation does not occur on the heat transfer surface; (3) using plate heat exchangers as the brine heater such that, even in the event of an excursion, recovery requires a CIP wash, or, at most, disassembly and physical removal of scale from plates; and (4) using hot water as the heat transfer medium on the hot side of the brine heater to facilitate easy drainage and disassembly of the plate heat exchanger when necessary. Optionally, the system may use two brine heaters in parallel for redundancy in the event the operational brine heater requires maintenance.
Reliable operation with limited resources in remote locations. The proposed system requires no non-electrical infrastructure. The pumps, plate heat exchanger, vacuum pump, and water-to-water heat pump can be maintained by lightly skilled labor.
Critical mineral recovery. The proposed system uses a robust, forced-circulation flash evaporator design that is especially suited to the propagation and growth of crystals within the bulk solution and, therefore, resilient to operation at/above saturation in order to precipitate out salts that would otherwise be difficult to separate using membrane processes (and without the risk of a membrane failure), thereby creating opportunities for selective crystallization of critical minerals for recovery.

In some embodiments, a brine concentration system (1) uses a fully-electric, ultra-low-temperature distillation (ULTD) process in order to reduce the cost of materials of construction; to reduce the capital and operating costs associated with conventional chemical softening; to reduce operating costs associated with maintenance due to scaling and corrosion; and to reduce energy cost; (2) achieves high recovery rates; (3) recovers from failure easily in remote locations distant from robust supply chains; (4) incorporates advanced controls for continuous, optimal, autonomous, cost-optimizing operation and remote monitoring; and (5) can be maintained, when needed, by lightly-skilled labor (e.g., refrigeration experience; rotating machinery experience).

In some embodiments, the disclosure described herein relate to a brine concentration system including: a heat exchanger configured to receive a mix of feedwater and recirculated brine and heat it before it passes into a flash tank; a flash tank configured to receive heated brine and evaporate brine to steam; a steam condenser configured to receive the steam from the flash tank and condense the steam to recover distilled water; heat pump; a closed-cycle heat pump to move heat between the brine heater and the steam condenser; an electric vacuum pump in connection with the steam condenser and the flash tank, the electric vacuum pump configured to reduce a pressure within the steam condenser and the flash tank to reduce a boiling point of the brine; and a controller in communication with the closed-cycle heat pump and the electric vacuum pump to dynamically adjust operations of the heat pump and/or the electric vacuum pump.

In some embodiments, the disclosure described herein relate to a system, wherein a difference between the first temperature range and the second temperature range is within 10 degrees Celsius.

In some embodiments, the disclosure described herein relate to a system, wherein the controller is configured to adjust the operations of the heat pump and/or the vacuum pump based on power rate plan data, power measurement data, and/or demand response data.

In some embodiments, the disclosure described herein relate to a system, wherein the controller includes one or more processors and memory configured to store code including instructions, wherein the instructions, when executed by the one or more processors, cause the one or more processors to: receive power rate data that indicates a power rate for a period is above a threshold; and responsive to the power rate for the period being above the threshold, reduce the speed of at least one of the heat pump and the vacuum pump during the period.

In some embodiments, the disclosure described herein relate to a system, wherein the controller includes one or more processors and memory configured to store code including instructions, wherein the instructions, when executed by the one or more processors, cause the one or more processors to: monitor one or more parameters including incoming feedwater salinity, brine recirculation salinity or available power; and adjust one or more operating levels, the one or more operating levels includes flowrates, vacuum level, or brine temperature.

In some embodiments, the disclosure described herein relate to a system, further including one or more sensors installed at: the heat exchanger, the brine heater, and/or the steam condenser, wherein the controller includes one or more processors and memory configured to store code including instructions, wherein the instructions, when executed by the one or more processors, cause the one or more processors to: determine a recovery rate of recovering the distilled water from the feedwater; receive one or more readings from the one or more sensors; and responsive to the one or more readings, adjust at least one of speeds of the heat pump and the vacuum pump to target the recovery rate.

In some embodiments, the disclosure described herein relate to a system, wherein the heat pump is a variable-speed compressor and the vacuum pump is a variable-speed vacuum pump.

In some embodiments, the disclosure described herein relate to a system, wherein the heat pump is part of a water-to-water heat pump subsystem.

In some embodiments, the disclosure described herein relate to a system, wherein a first brine heater and a second brine heater are arranged in parallel, and the first and second brine heaters are connected to directional control valves to direct recirculated brine from/to the flash tank.

In some embodiments, the disclosure described herein relate to a system, wherein the brine heater is physically arranged below the steam condenser within a vacuum cavity.

In some embodiments, the disclosure described herein relate to a system, wherein the first temperature range is between 20 degrees and 30 degrees Celsius.

In some embodiments, the disclosure described herein relate to a system, wherein the second temperature range is between 5 degrees and 20 degrees Celsius.

In some embodiments, the disclosure described herein relate to a non-transitory computer-readable medium, wherein the instructions, when executed, further cause the one or more processors to: determine a recovery rate of recovering the distilled water from the feedwater; receive one or more readings from one or more sensors; and responsive to the one or more readings, adjust at least one of speeds of the heat pump and the vacuum pump to target the recovery rate.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

FIG. 1 is a block diagram illustrating a system for brine concentration, according to an embodiment.

FIG. 2A is a block diagram of a brine concentration system according to an embodiment.

FIG. 2B is a block diagram of a brine concentration system according to an embodiment.

FIG. 2C is a block diagram of a brine concentration system according to an embodiment.

FIG. 2D is a schematic diagram of a brine concentration system inclusive of a first vacuum system arrangement, according to an embodiment.

FIG. 3 is a schematic diagram of a second vacuum system arrangement for a brine concentration system that is different from the first vacuum system arrangement of FIG. 2D, according to an embodiment.

FIG. 4 is a block diagram of a control system for a brine concentration system, according to an embodiment.

FIG. 5 is a block diagram of a method of desalinating brine, according to an embodiment.

FIG. 6 is a cycle model of one embodiment of a brine concentration system with incoming feedwater at 70° F., a TBT of 70° F., and a recovery rate of 25%.

FIG. 7 is a cycle model of one embodiment of a brine concentration system with incoming feedwater at 70° F., a TBT of 70° F., and a recovery rate of 50%.

FIG. 8 is a cycle model of one embodiment of a brine concentration system with incoming feedwater at 70° F., a TBT of 70° F., and a recovery rate of 85%.

FIG. 9 is a cycle model of one embodiment of a brine concentration system with incoming feedwater at 70° F., a TBT of 110° F., and a recovery rate of 25%.

FIG. 10 is a cycle model of one embodiment of a brine concentration system with incoming feedwater at 70° F., a TBT of 110° F., and a recovery rate of 50%.

FIG. 11 is a cycle model of one embodiment of a brine concentration system with incoming feedwater at 70° F., a TBT of 110° F., and a recovery rate of 85%.

FIG. 12 is a cycle model of one embodiment of a brine concentration system with incoming feedwater at 70° F., a TBT of 80° F., and a recovery rate of 85%.

FIG. 13 is a block diagram of a method of a startup procedure for a brine concentration system, according to an embodiment.

FIG. 14 is a block diagram of a method of a shutdown procedure for a brine concentration system, according to an embodiment.

FIG. 15 is a block diagram of a method of operating a brine concentration system on a time-of-use utility rate plan, according to an embodiment.

FIG. 16 is a block diagram of a method of operating a brine concentration system in response to the power available from an external power source, according to an embodiment.

FIG. 17 is a block diagram of a method of operating a brine concentration system responsive to a demand response signal, according to an embodiment.

FIG. 18 is a block diagram of a method of operating a brine concentration system in response to a loss of power from an external power source, according to an embodiment.

FIG. 19 is a schematic diagram of an arrangement by which a brine concentration system interfaces with a utility grid, according to an embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overview

Referring to the figures generally, embodiments disclosed herein relate to modular (e.g., small scale, decentralized, etc.) systems for brine concentration that are configured to concentrate brine and to produce clean water from a wide variety of different aqueous feedwater sources. The systems of the present disclosure are configured to automatically adjust process conditions in response to user-specified criteria and/or based on real-time conditions, including feedwater conditions, conditions in the brine heater, or electricity conditions, and/or to accommodate intermittent operation in different environments without significantly reducing the longevity of the system or system performance.

The brine concentration systems of the present disclosure include a closed-cycle heat pump that couples a brine heater and a steam condenser and produces the temperature differences and heat flows needed for the evaporation of feedwater and subsequent condensation of feedwater steam to distillate. The brine concentration systems also include a vacuum system that is configured to maintain low pressure in the steam condenser and in the flash tank downstream of the brine heater during system operation by continuously ejecting non-condensable gas. In various embodiments, both the closed-cycle heat pump and the vacuum system may include variable speed/capacity equipment to enable brine concentration across a wide variety of process conditions, including evaporation at and below ambient feedwater temperature conditions.

Vapor compression refrigeration systems have four main components: a compressor, a condenser, an expansion valve, and an evaporator. The term “heat pump” typically implies the addition of a fifth component—a reversing valve—for changing the direction of refrigerant flow, such that the refrigerant loop can flow one way (e.g., to transfer heat from indoors to outdoors in the summer) or be reversed to flow the other way (e.g., to transfer heat from outdoors to indoors in the winter). As used herein, “heat pump” refers generically to a vapor compression refrigeration system, and does not imply or require the presence of a reversing valve.

“Variable flow rate” as used herein encompasses variable speed, variable capacity, and variable pressure ratio when used in connection with compressors and vacuum devices.

In some embodiments, the vacuum system includes a vacuum device that is disposed downstream of the steam condenser. Such an arrangement enables operation without drawing large volumes of steam through the vacuum device. Instead, the steam is condensed before reaching the vacuum device. Thus, a smaller vacuum device can maintain the necessary low pressures during operation because only the non-condensable gases (NCGs) released from the feedwater are pumped out of the system.

The system is also configured to adjust its operating point in response to user-selected criteria and/or real-time conditions. For example, the brine concentration system may include a control system that is configured to control operation of the fluid pumps, closed-cycle heat pump (e.g., a variable speed compressor) and vacuum device (e.g., a variable-speed vacuum pump) based on user-specified criteria. For example, the control system may be configured to control concentration of the brine to achieve a desired recovery ratio.

The system is also configured for intermittent operation and/or across a variety of different power levels. For example, the system may include a control system that is configured to control operation of the fluid pumps, closed-cycle heat pump (e.g., a variable speed compressor) and vacuum device (e.g., a variable-speed vacuum pump) based on available power, which can enable operation of the brine concentration system in different conditions, environments, and applications. In another embodiment, the system may be configured to optimize operation of the heat pump for high efficiency. The control system may also be configured to control activation and deactivation of the brine concentration system based on available power (e.g., in off-grid scenarios).

### System Environment

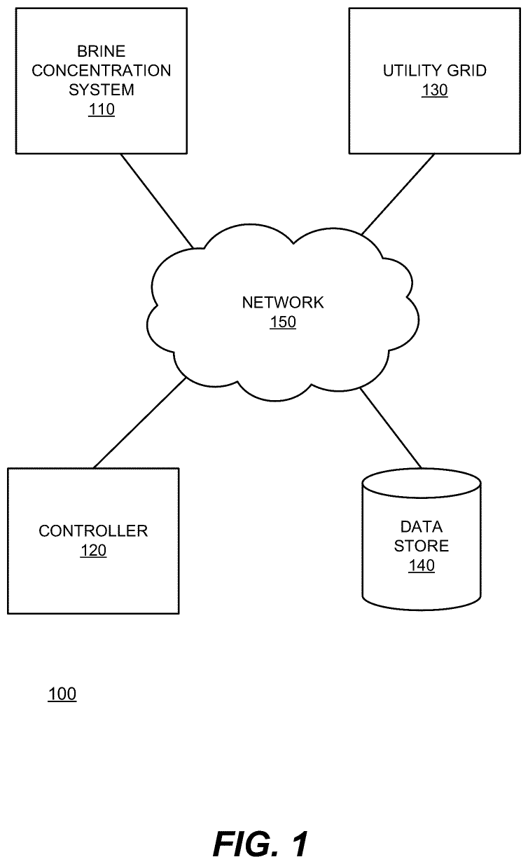

FIG. 1 illustrates a system 100 for brine concentration, in accordance with an embodiment. The system 100 may include a brine concentration system 110, a controller 120, a utility grid 130, and a data store 140. In various embodiments, the system 100 may include different, fewer, or additional components.

The components in the system 100 may each correspond to a separate and independent entity or may be controlled by the same entity. For example, in one embodiment, the controller 120 is controlled by a first entity that provides remote controls to different brine concentration systems 110, each of which is physically located at a customer site or controlled by the customer. In one embodiment, the controller 120 and a brine concentration system 110 are controlled by the same entity. The utility grid 130 may be controlled by a utility company or a local power grid operator and may provide power data to the controller 120 for the operation of a brine concentration system 110.

The components in the system 100 may be geographically located in the same location or distributed in various locations. In one embodiment, the controller 120 and a brine concentration system 110 are combined as a single device, providing an all-in-one salutation for a dynamic and controllable brine concentration process. In one embodiment, the controller 120 can be a separate controlling device that is in communication with multiple brine concentration systems 110 at a site. In one embodiment, the controller 120 is a remote server, such as a computing server providing a Software as a Service (SaaS) platform.

While each of the components in the system 100 is sometimes described in disclosure in a singular form, the system 100 may include one or more of each of the components. For example, multiple brine concentration systems 110 may be controlled by a single controller 120.

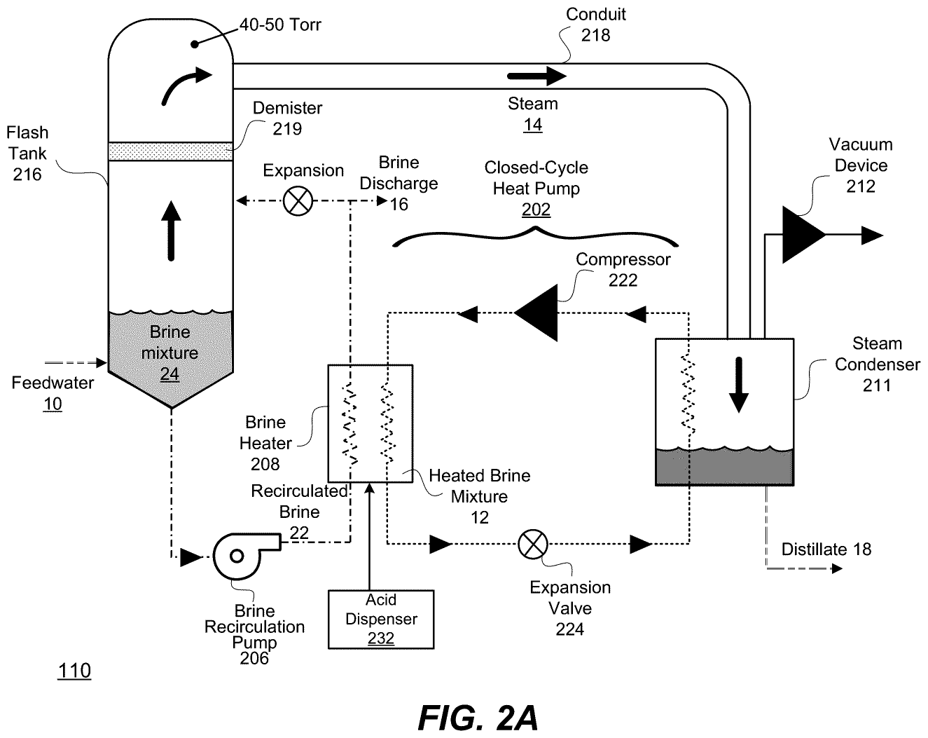

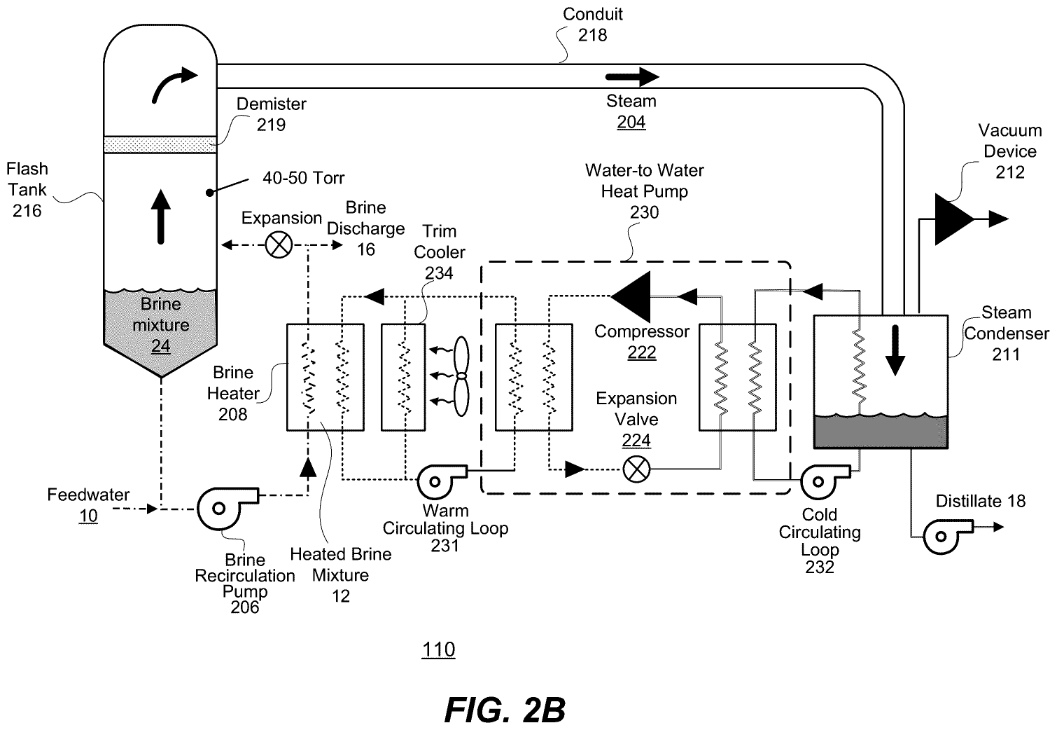

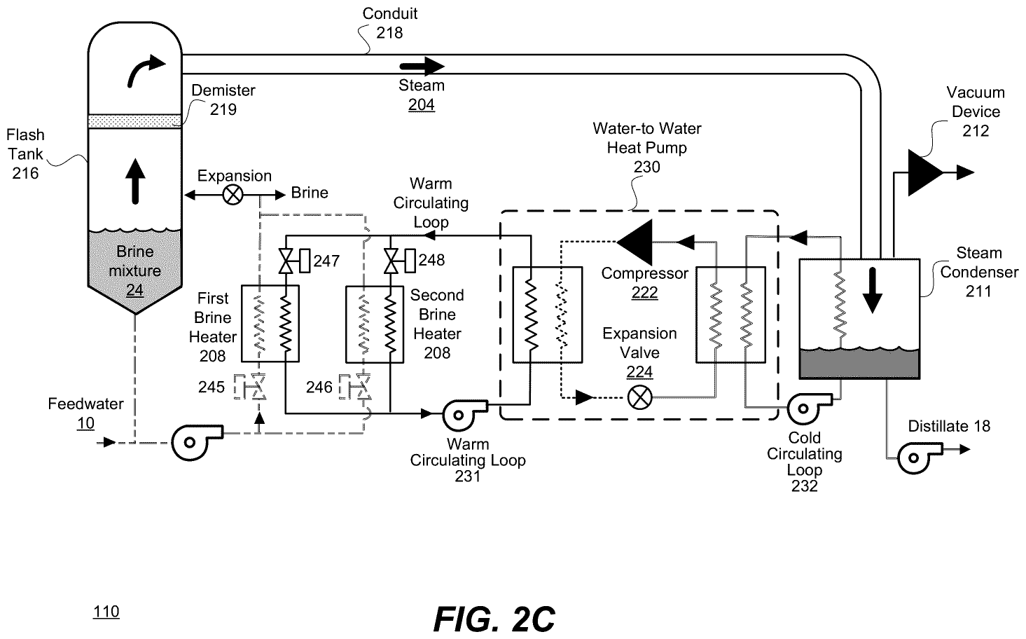

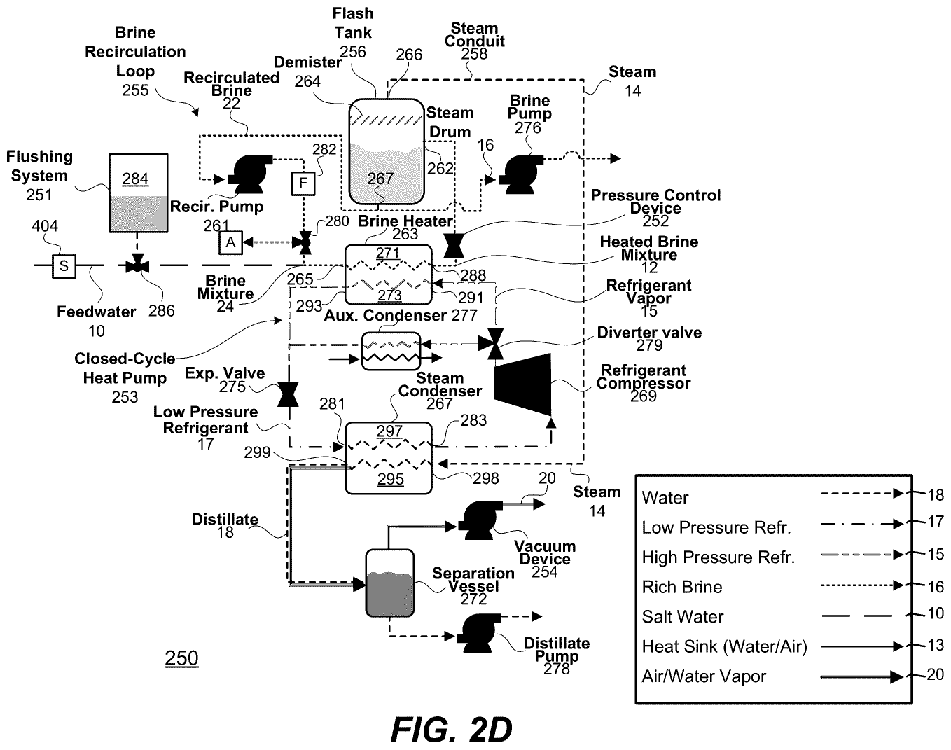

A brine concentration system 110 may take the form of a device concentrates brine, such as brackish water reverse osmosis concentrate, recovers clean water, and increases the concentration of the residual brine to reduce the volume of the brine to be discarded. Examples of detailed components and configurations of brine concentration systems 110 are further discussed in FIG. 2A through FIG. 13. In one embodiment, a brine concentration system 110 is a fully electric system that controls various components of the brine concentration system 110 without the reliance on an external specialized source, such as external steam. The fully electric system allows the brine concentration system 110 to be installed in a variety of environments and sites that may not be able to support an external specialized source. In some embodiments, the fully electric system also allows the controller 120 to better control various components in the brine concentration system 110 to achieve a desirable recovery rate. A brine concentration system 110 may include various sensors at different components to measure parameters within the brine concentration system 110 and provide those measured parameters to a controller 120 to perform control and regulation of the brine concentration system 110.

A controller 120 is a controlling device that is used to regulate one or more parameters of a brine concentration system 110. The controller 120 may receive signals from various sources to regulate a brine concentration system 110. For example, first, the controller 120 may receive signals from various sensors of the brine concentration system 110 to perform feedback control of the brine concentration system 110. Second, controller 120 may receive power data, such as throttling requirements, power cost parameters, and duration requirements, from the utility grid 130 and adjust the operation of the brine concentration system 110 accordingly. Third, the controller 120 may receive analytics data from the data store 140 and control the brine concentration system 110 according to one or more analytics. The controller 120 may monitor incoming feedwater salinity, brine recirculation salinity, and other parameters (available power)—and automatically adjust flowrates, vacuum level, brine temperature, etc., adaptively in real-time to optimize the recovery rate.

In various embodiments, a controller 120 may take different forms. In one embodiment, a controller 120 is a microcontroller that is part of the brine concentration system 110 and directly controls the rest of the components in the brine concentration system 110. In one embodiment, a controller 120 is a computing device that is located on-site with one or more brine concentration systems 110 and regulates the brine concentration systems 110 in a systemic manner, such as in a control room operated by an operator. In one embodiment, a controller 120 may be a smart device such as a smartphone, a tablet, or a laptop computer, that can remotely control a brine concentration system 110 through a software application. In one embodiment, a brine concentration system 110 is in remote communication with a controller 120, which may take the form of an online server (e.g., a cloud server). For example, a customer may control a brine concentration system 110 through a SaaS platform or any suitable software platform. In various configurations, the controller 120 may provide analytics related to the usage of the brine concentration system 110, such as power consumption, recovery rate over time, and other measurements, and may also provide alerts and other control analyses to operators.

In one embodiment, a controller 120 may take the form of a server that may take various forms. In one embodiment, a server may be a server computer that includes one or more processors and memory that stores code instructions that are executed by the one or more processors to perform various processes described herein. In one embodiment, a server may be a pool of computing devices that may be located at the same geographical location (e.g., a server room) or be distributed geographically (e.g., cloud computing, distributed computing, or in a virtual server network). In one embodiment, a server may be a collection of servers that independently, cooperatively, and/or distributively provide various products and services described in this disclosure. A server may also include one or more virtualization instances such as a container, a virtual machine, a virtual private server, a virtual kernel, or another suitable virtualization instance.

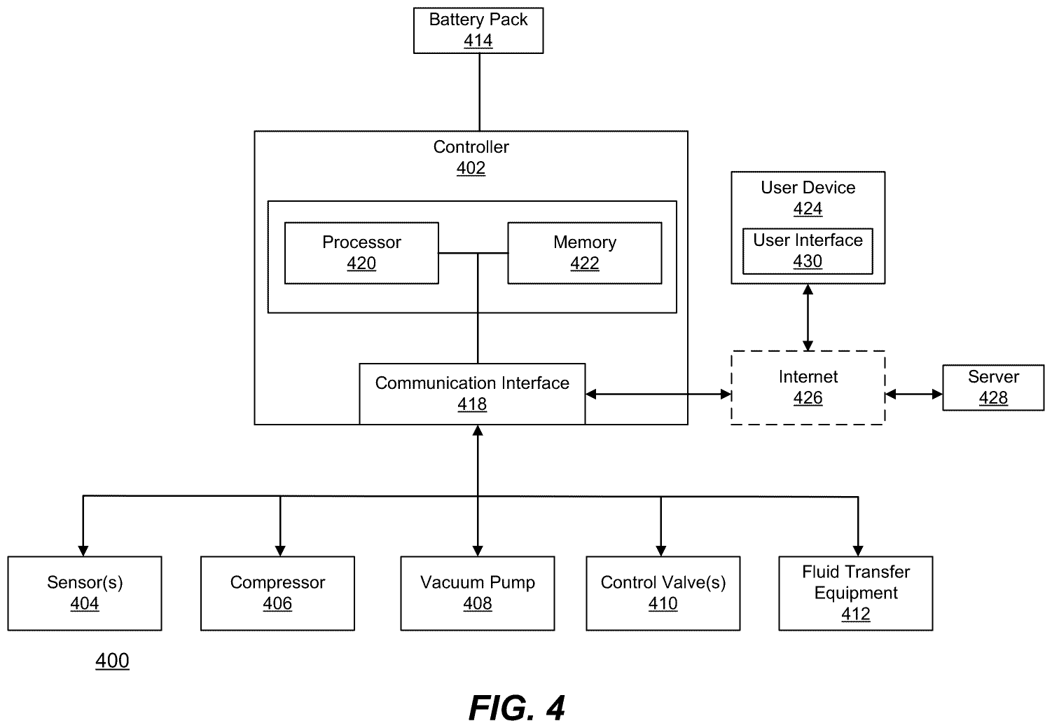

Further discussions of the communication and connection between a controller 120 and various components of a brine concentration system 110 are described in FIG. 4.

A utility grid 130 is configured to distribute electrical power from generation sources to the brine concentration system 110 to drive the brine concentration system 110. A utility grid 130 may be operated by a utility provider or be a local microgrid. The utility grid 130 may provide other power consumption data, such as demand response data, power option and contract data, time-dependent power cost, duration of power cost, throttling requirements, and other information and data related to the utility grid 130. The controller 120 may receive the data from the utility grid 130 and regulate a brine concentration system 110 accordingly, such as by adjusting the target recovery rate of the brine concentration system 110 based on the power cost, lowering the compressor power consumption based on the power cost or throttling requirement, etc.

A data store 140 serves as a repository for storing operation data and analysis related to the operation of a brine concentration system 110 and may also store data related to the utility grid 130. The data store 140 includes one or more storage units such as memory that takes the form of a non-transitory and non-volatile computer storage medium to store various data. The computer-readable storage medium is a medium that does not include a transitory medium such as a propagating signal or a carrier wave. The data store 140 may be used by a controller 120 to store data related to a brine concentration system 110. In some embodiments, the data store 140 communicates with other components by a network. This type of data store 140 may be referred to as a cloud storage server. Examples of cloud storage service providers may include AMAZON AWS, DROPBOX, RACKSPACE CLOUD FILES, AZURE, GOOGLE CLOUD STORAGE, etc. In some embodiments, instead of a cloud storage server, the data store 140 is a storage device that is controlled and connected to the controller 120. For example, the data store 140 may take the form of memory (e.g., hard drives, flash memory, discs, ROMs, etc.) used by the controller 120 such as storage devices in a storage server room that is operated by the controller 120.

In the system 100, one or more components may communicate locally if the components are physically located in proximity. In some embodiments, the components may communicate via one or more networks 150. The networks 150 may include multiple communication networks that provide connections to the components of the system 100 through one or more sub-networks, which may include any combination of local area and/or wide area networks, using both wired and/or wireless communication systems. In one embodiment, a network 150 uses standard communications technologies and/or protocols. For example, a network 150 may include communication links using technologies such as Ethernet, 802.11, worldwide interoperability for microwave access (WiMAX), 3G, 4G, Long Term Evolution (LTE), 5G, code division multiple access (CDMA), digital subscriber line (DSL), etc. Examples of network protocols used for communicating via the network 150 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over a network 150 may be represented using any suitable format, such as hypertext markup language (HTML), extensible markup language (XML), JavaScript object notation (JSON), and structured query language (SQL). In some embodiments, all or some of the communication links of a network 150 may be encrypted using any suitable technique or techniques such as secure sockets layer (SSL), transport layer security (TLS), virtual private networks (VPNs), Internet Protocol security (IPsec), etc. The network 150 also includes links and packet-switching networks such as the Internet.

### Brine Concentration System

Referring to FIG. 2A, a functional diagram of brine concentration system 110 is shown, according to an embodiment. Brine concentration system 110 is configured to concentrate brine and to produce clean distillate from a wide variety of brine sources, including by evaporating brine near ambient temperature conditions without requiring an external heat source. For example, brine concentration system 110 may be configured to evaporate brine at temperatures of less than or equal to 34° C. (92° F.), 30° C. (86° F.), 25° C. (77° F.), 20° C. (68° F.), 15° C. (59° F.), 10° C. (50° F.), or less, or a range between and including any two of the foregoing values.

Brine concentration system 110 is also configured to evaporate not just brackish EDR/RO concentrates, but brines of all nontraditional water sources, including food and beverage wastewater, industrial wastewater, municipal wastewater, agricultural wastewater, mining wastewater, produced water, lithium brine, semiconductor fabrication wastewater, and power and cooling wastewater. Concentrating brine is particularly beneficial in applications where reducing the volume of impaired water product equates to lower disposal costs, e.g., to reduce a volume of produced water at an oil/gas site, to reduce the volume of impaired water at a metal finishing shop, or to concentrate lithium brine to a desired salinity and return freshwater to the aquifer or for local consumption.

In some embodiments, brine concentration system 110 is configured for small-scale, decentralized applications, in applications generating upwards of 1 L/min (0.26 gal/min), 3.8 L/min (1 gal/min), 38 L/min (10 gal/min), or 189 L/min (50 gal/min) of distillate, or greater, or a range between and including any two of the foregoing values.

Brine concentration system 110 includes closed-cycle heat pump 202, brine recirculation pump 206, brine heater 208, steam condenser 211, vacuum device 212, and flash tank 216.

In the embodiment shown in FIG. 2A, brine heater 208 receives and heats feedwater mixed with recycled brine, which then enters flash tank 216 through a pressure control device (e.g., an expansion valve, an orifice, or a liquid level providing sufficient head to suppress flashing). Steam condenser 211 condenses steam evaporated in flash tank 216. In some embodiments, the brine heater may be physically arranged at the bottom and the steam condenser physically arranged at the top of a single chamber under vacuum.

In the embodiment of FIG. 2A, vacuum device 212 is configured to maintain steam condenser 211 and flash tank 216 at a target pressure during operation. Vacuum device 212 draws air out of the steam condenser and of the flash tank to lower the ambient pressure within the condenser and the flash tank. In various embodiments, the flash tank and steam condenser operate at a “rough” or “low” vacuum range that is lower than atmospheric pressure.

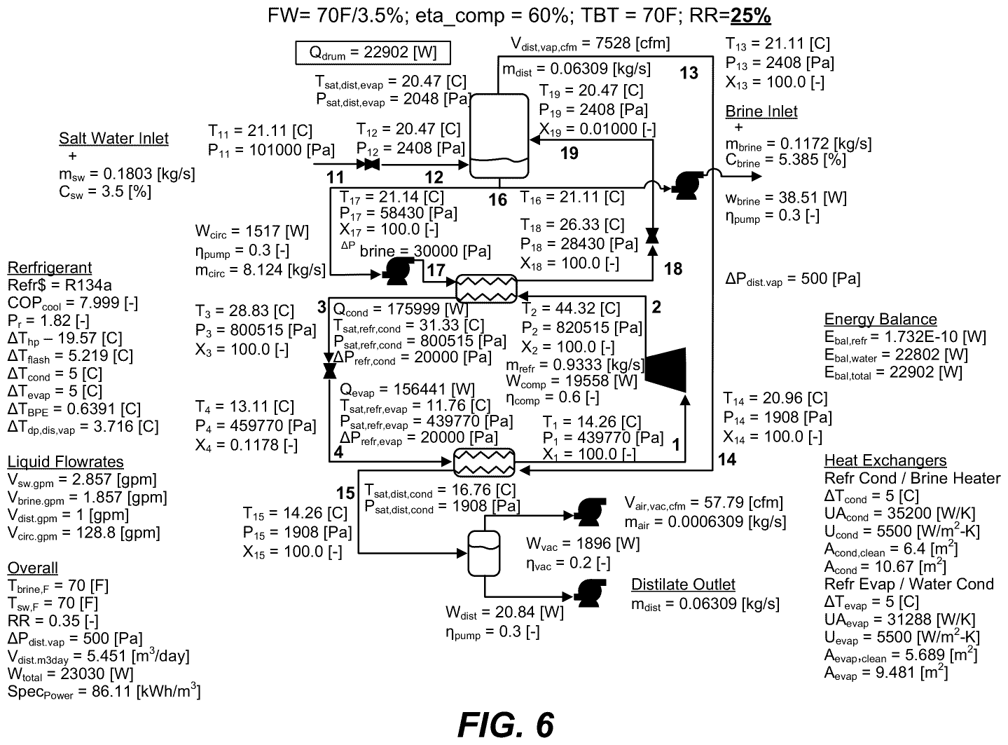

In some embodiments, vacuum device 212 may take the form of an electric, single-stage vacuum pump that can draw the pressure of the flash tank to a target level. Various target pressure levels are illustrated in FIG. 6 through FIG. 12. Conventional distillers use steam ejectors, which cannot draw the pressure of a chamber low enough to achieve the process conditions discussed in this disclosure.

Closed-cycle heat pump 202 includes a circulated refrigerant and working components of brine concentration system 110 that heats brine and condenses steam. Closed-cycle heat pump 202 moves heat between brine heater 208 and steam condenser 211. Closed-cycle heat pump 202 includes a hot zone with the refrigerant at a first temperature range (e.g., including operating a precise temperature or a range). The hot zone is in heat exchange with brine heater 208 to heat the mix of feedwater and recirculated brine. Closed-cycle heat pump 202 also includes a cold zone with the refrigerant at a second temperature range lower than the first temperature range. The cold zone is in heat exchange with steam condenser 211 to cool the steam, condensing it to distilled water.

Closed-cycle heat pump 202 may take the form of a variable-speed compressor. Compressor 222 is configured to raise the temperature of the refrigerant back to the first temperature range at the hot zone through a thermodynamic process. For example, compressor 222 compresses refrigerant vapor to a higher temperature, the heated refrigerant vapor runs through brine heater 208, where the refrigerant condenses and transfers heat to the recirculated brine and feedwater. The refrigerant then passes through expansion valve 224 where the refrigerant expands, partially evaporates, and cools. The cool refrigerant then passes through steam condenser 211, where the refrigerant fully evaporates and absorbs the latent heat of condensation from the steam, and returns to compressor 222.

In some embodiments, compressor 222 is a variable speed compressor so that the amount of heat added by brine heater 208 may be dynamically controlled by a controller 120. For example, compressor 222 may increase or decrease the temperature of the hot zone. The speed of the compressor 222 may be determined by the controller 120 (not shown in FIG. 2A) based on sensor readings in the system 100, electric rate, feedwater volume, etc.

In some embodiments, excess heat may be removed from the system using an auxiliary heat exchanger arranged in parallel with brine heater 208, as depicted in FIG. 2B by Trim Cooler 234, described in more detail below.

During operation, feedwater 10 is introduced into the brine recirculation path where feedwater 10 mixes with recirculated brine 22 discharged from brine recirculation pump 106 before entering brine heater 208, which raises the temperature of feedwater 10 above its ambient temperature forming heated brine mixture 12. Heated brine mixture 12 is then pumped through a pressure control device into flash tank 216 maintained at a vacuum level corresponding to the boiling point of heated brine mixture 12, whereupon a first portion of heated brine mixture 12 “flashes” to steam 14, a portion of dissolved gases in heated brine mixture 12 “flash” to non-condensable gases, and a second portion of heated brine mixture 12 collects as brine at the bottom of the flash tank. In some embodiments, the pressure control device may be an expansion valve. In some embodiments, the pressure control device may be an orifice. In other embodiments, the pressure control device may be a height of liquid level sufficient to suppress flashing in brine heater 208. A first portion of the brine at the bottom of the flash tank is pumped from the system via a brine outlet. A second portion of the brine at the bottom of the flash tank is recirculated and mixed with more incoming feedwater 10.

Steam 14 has low density, which results in high vapor velocities. The droplet carrying capacity of the vapor flow is a function of vapor density multiplied by vapor velocity squared. Thus, at low temperatures and vapor pressures, the vapor volume flow gets very large and the droplet carrying capacity gets higher despite the low vapor density because of the vapor velocity squared term. Thus, in some embodiments, flash tank 216 may include a tangential inlet for the brine flow, extra height in the flash tank, a demister 219, and/or extra measures (e.g., swirls, cyclones, etc.) in the demister to reduce entrainment of small droplets in the vapor.

Referring still to FIG. 2A, steam 14 leaving flash tank 216 is delivered via conduit 218 into steam condenser 211 at constant pressure. Steam condenser 211 cools and condenses steam 14 to generate distillate 18. Vacuum device 212 is coupled downstream of steam condenser 211. As steam 14 condenses to distillate 18 in steam condenser 211, vacuum device 212 removes any non-condensable gases released from heated brine mixture 12 during evaporation. Distillate 18 may then be pumped from the system for use.

In some embodiments, brine concentration system 110 also includes automated acid dispenser 232 for adjusting the pH of the recirculating brine loop. In one embodiment, the automated acid dispenser is configured to receive a replaceable container of acid that can be swapped when it runs empty. If a feedwater has CaCO₄, for example, the acid dispensing system dispenses acid (e.g., sulfuric acid, hydrochloric acid, etc.) to maintain the pH of the recirculating brine stream at a target pH (e.g., 5.5). In one embodiment, brine concentration system 110 includes one or more sensors to control the target pH at brine heater 208 and the automatic dispense of acid. For example, the sensors are in communication with controller 120 to provide a feedback control loop of the pH at the brine heater. The sensors may include pH sensors, such as glass electrode sensors, ion-selective field effect transistor pH sensors, solid state pH sensors, etc. to measure the pH level of the brine. The sensors may also include a flow rate sensor, a weight sensor, or a volume sensor that monitors the amount of acid dispensed to brine heater 208 and the remaining acid in the replaceable container to allow controller 120 to trigger a notification alert for the replacement of the acid container. In response to the pH being higher than the target pH, controller 120 sends a command to dispense the acid and monitors the amount of the acid dispensed based on the flow rate or volume/weight change in the acid container. The dispensing of acid may be controlled based on the feedback of the pH sensors, such as by monitoring when the target pH is reached at brine heater 208, and/or by determining the amount of acid needed to bring the brine to a target pH based on the current measured pH at the brine and the volume of the brine.

FIG. 2B illustrates a brine concentration system 100 that is similar to the embodiment shown in FIG. 2A, in accordance with some embodiments. In FIG. 2B, water-to-water heat pump (W2WHP) 230 interfaces with brine heater 208 via circulating warm water loop 231 and interfaces with steam condenser 211 through circulating cold water loop 232 to move heat between brine heater 208 and steam condenser 211. W2WHP 230 is based on a vapor compression system, in which: (1) low-pressure, liquid refrigerant evaporates to cool cold water loop 232, and (2) high pressure refrigerant vapor condenses to heat warm water loop 231.

In some embodiments, trim cooler 234 is arranged in parallel with brine heater 208. Excess heat may be removed from the system using trim cooler 234.

FIG. 2C is a conceptual block diagram illustrating part of a brine concentration system 110 that is similar to the embodiment shown in FIG. 2B, in accordance with some embodiments. In this embodiment, two brine heaters 208 (instead of one brine heater 208 in FIG. 2B) are arranged in parallel. The mix of recirculated brine and feedwater is directed to one of the two brine heaters 208 via first valve 245 and second valve 246. Warm circulating loop 231 is directed to the operational brine heater via third valve 247 and fourth valve 248. After leaving the brine heater, heated brine mixture is directed to flash tank 216. This arrangement allows maintenance and replacement of the first brine heater 208 while operation continues using the second brine heater 208.

Referring to FIG. 2D, a schematic diagram of another brine concentration system 250 is shown that is configured to operate in a similar manner as brine concentration system 110 of FIG. 2A. Brine concentration system 250 includes closed-cycle heat pump 253, brine recirculation flash tank 256, brine recirculation loop 255 including circulation pump 261, variable flow-rate vacuum device 254, and a control system (not shown). In the embodiment of FIG. 2D, brine concentration system 250 also includes brine recirculation loop 255 and flushing system 251. In other embodiments, brine concentration system 250 may include additional, fewer, and/or different components. For example, although not shown here, certain embodiments of the system may include a feedwater pump to pump feedwater 10 into brine recirculation loop 255.

Feedwater 10 is mixed with recirculated brine 22 to form brine mixture 24.

Closed-cycle heat pump 253 is configured to transfer heat between steam 14 and brine mixture 24. Closed-cycle heat pump 253 includes brine heater 263, steam condenser 267, refrigerant compressor 269, expansion valve 275, auxiliary condenser 277, and diverter valve 279.

Brine heater 263 is configured to increase the temperature of brine mixture 24 upstream of flash tank 256.

In the embodiment of FIG. 2D, brine heater 263 comprises a heat exchanger with mixed feedwater 10 and recirculated brine 22 on one side (e.g., first side 271) and compressed (heated) refrigerant vapor 15 on the other side (e.g., second side 273). Brine heater 263 may be any form of heat exchanger known in the art, including shell-and-tube, plate-and-frame, spiral tube, etc. Brine heater 263 includes brine heater inlet 265 and brine heater outlet 288 on the first side, and condenser inlet 291 and condenser outlet 293 on the other side (e.g., the closed-cycle heat pump side, etc.). Brine heater 263 is configured to receive brine mixture 24 through brine heater inlet 265 and to discharge heated brine mixture 12 through brine heater outlet 288. Closed-cycle heat pump 253 directs high pressure working fluid (e.g., refrigerant vapor 15) into brine heater 263 through condenser inlet 291, which is discharged through condenser outlet 293 to expansion value 275.

Steam condenser 267 is configured to cool steam 14 leaving flash tank 256 and to condense the steam to distillate. Steam condenser 267 comprises a heat exchanger with steam 14 on one side (e.g., first side 295) and expanded (cold) refrigerant on the other side (e.g., second side 297). Steam condenser 267 may be any form of heat exchanger known in the art, including shell-and-tube, plate-and-frame, spiral tube, etc. However, because of the low pressures, low steam density, and high vapor velocities at which it is operating, steam condenser 267 is preferably a shell-and-tube or plate-and-frame heat exchanger. Steam condenser 267 includes steam condenser inlet 298 and steam condenser outlet 299 on the first side, and evaporator inlet 281 and evaporator outlet 283 on the second side. Because of the low pressures, low steam density, and high vapor velocities at which steam enters steam condenser 267, inlet 298 preferably has a diameter of 7 inches or more. Closed-cycle heat pump 253 directs low pressure working fluid (e.g., low pressure refrigerant 17) from expansion value 275 to evaporator inlet 281, which is discharged through evaporator outlet 283 to compressor 269.

Brine heater 263 and steam condenser 267 may be made from the same or different types of heat exchangers in various embodiments. For example, both may be plate and frame heat exchangers, or brine heater 263 may be a plate and frame heat exchanger and steam condenser 267 may be a shell and tube heat exchanger. Because the feedwater side of the heat transfer surfaces of brine heater 263 are in contact with dissolved solids, the heat transfer surfaces of brine heater 263 are preferably made of a corrosion-resistant material, such as titanium. Because the steam side heat transfer surfaces of steam condenser 267 are not in contact with dissolved solids, the heat transfer surfaces of steam condenser 267 may be made of a less corrosion-resistant material, such as 316 stainless steel. If brine heater 263 and/or steam condenser 267 is a plate-and-frame heat exchanger, the plates are preferably welded, instead of gasketed, on the refrigerant side.

Compressor 269 is configured to power operation of closed-cycle heat pump 253 and to control the flow rate of a working fluid (e.g., refrigerant) through closed-cycle heat pump 253. In some embodiments, compressor 269 is a variable flow rate compressor (e.g., a variable-speed compressor or variable-capacity compressor) that is controllable to modify flow rate based on a mode of operation and real-time conditions, such as varying feedwater conditions, power conditions, and/or to accommodate variations in operating conditions in different applications. In some embodiments, compressor 269 is a scroll compressor (e.g., a DC brushless scroll compressor, etc.). In other embodiments, compressor 269 is a centrifugal compressor (e.g., a turbocompressor). In yet other embodiments, multiple compressors are arranged in parallel, as is known in the art.

Closed-cycle heat pump 253 may be used with a wide variety of working fluids (e.g., refrigerants). In various embodiments, closed-cycle heat pump 253 is configured for use with a low global warming potential, ozone friendly refrigerant, such as R1234yf, carbon dioxide/R744, or another environmentally friendly refrigerant or refrigerant mixture. In other embodiments, closed-cycle heat pump 253 is configured for use with a common refrigerant like R134a.

Auxiliary condenser 277 is configured to cool the refrigerant for the closed-cycle heat pump 253 under certain operating conditions to avoid increasing brine temperatures above temperature thresholds. By dumping excess heat to air, such an arrangement avoids boiling brine mixture 24, and thereby reduces scaling risk while enabling compressor 269 to operate at more efficient speeds. In the embodiment of FIG. 2D, auxiliary condenser 277 is disposed downstream of compressor 269 in a parallel flow arrangement with brine heater 263, which can enable more direct and rapid control of the flow rate of the working fluid (and heat transferred to brine heater 263) relative to a series flow arrangement. Such an arrangement is particularly advantageous in closed-cycle heat pump 253 of the present disclosure, which aims to operate closed-cycle heat pump 253 in a narrower temperature range than conventional systems. In some embodiments, closed-cycle heat pump 253 also includes diverter valve 279 to control the flow rate through auxiliary condenser 277, and to enable automatic adjustment of heat transferred to brine heater 263.

In other embodiments, closed-cycle heat pump 253 includes additional, fewer, and/or different components. For example, in some embodiments, closed-cycle heat pump 253 includes a second auxiliary heat exchanger fluidly coupled to compressor 269 in parallel flow arrangement with brine heater 263. Secondary auxiliary heat exchanger may be used instead of, or in addition to, auxiliary condenser 277 to pre-cool the refrigerant upstream of brine heater 263. For example, second auxiliary heat exchanger may be fluidly coupled to a cooling system that is configured to adjust the amount of cooling provided to the working fluid (e.g., by controlling a flow rate of coolant through second auxiliary heat exchanger, etc.).

Variable flow-rate vacuum device 254 is configured to maintain flash tank 256, steam conduit 258, and steam condenser 267 at reduced pressure. Brine heater 263 is kept at higher pressure by pressure control device 252 (e.g., an expansion valve, an orifice, or a liquid level providing sufficient head to suppress flashing), through which heated brine mixture 12 must pass to enter flash tank 256, such that brine mixture 24 does not boil while in contact with the heat transfer surfaces of brine heater 263.

Heated brine mixture 12 flashes through pressure control device 252 into flash tank 256. In some embodiments, flash tank 256 is sized to enable a continuous flow rate into flash tank 256 while maintaining reduced pressures of less than or equal to 3.4 kPa (absolute) (0.5 PSIA) or less.

Flash tank 256 includes vessel inlet 262 and multiple vessel outlets, shown as first vessel outlet 266 and second vessel outlet 267. Vessel inlet 262 is fluidly coupled to flash tank 256 via pressure control device 252. First vessel outlet 266 is coupled to steam conduit 258. In some embodiments, flash tank 256 also includes demister 264 (e.g., droplet eliminator, etc.), such as a demister pad or another type of mist reducer or eliminator disposed within flash tank 256 between pressure control device 252 and steam conduit 258. Demister 264 is configured to remove water droplets entrained in steam 14 so that dissolved solids in those droplets are not transferred to steam condenser 267 and, in turn, distillate 18.

Brine recirculation pump 261 pumps concentrated brine from flash tank 256 through second vessel outlet 267.

In some embodiments, flash tank 256 forms part of brine recirculation loop 255 that is configured to return concentrated brine back through brine heater 263, as will be further described.

Steam conduit 258 fluidly couples flash tank 256 to steam condenser 267. Steam conduit 258 may be a vacuum rated conduit (e.g., stainless steel tubing or pipe, etc.) that extends between flash tank 256 and steam condenser 267.

In the embodiment of FIG. 2D, the system includes water-separation vessel 272 that is configured to collect distillate 18 from steam condenser 267 and to facilitate removal of non-condensable gases 20 from the process stream. Water-separation vessel 272 is fluidly coupled to steam condenser outlet 299.

Variable flow-rate vacuum device 254 is configured to maintain flash tank 256, steam conduit 258, steam condenser 267, and water-separation vessel 272 at reduced pressure. In the embodiment of FIG. 2D, variable flow-rate vacuum device 254 is fluidly coupled to an upper end of water-separation vessel 272, which reduces the risk of water ingestion into variable flow-rate vacuum device 254 (as the steam condenses to distillate upstream of variable flow-rate vacuum device 254). In some embodiments, variable flow-rate vacuum device 254 is a variable flow rate vacuum device (e.g., a variable-speed vacuum pump) that is controllable to adjust the pressure in flash tank 256, steam conduit 258, and steam condenser 267 based on application-specific requirements, such as feedwater temperature or feedwater salinity level. In some embodiments, variable flow-rate vacuum device 254 is a screw vacuum pump. In other embodiments, variable flow-rate vacuum device 254 is a variable displacement piston pump, scroll pump, rotary vane pump, rotary piston pump, liquid ring pump, or roots-type pump.

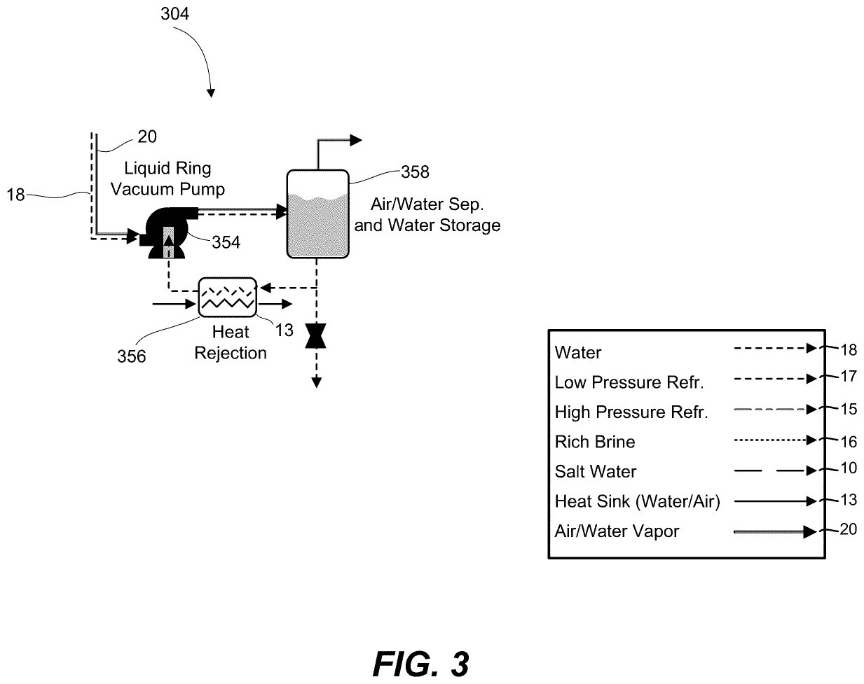

FIG. 3 illustrates an alternative embodiment in which variable flow rate liquid ring pump 354 maintains flash tank 256, steam conduit 258, and steam condenser 267 at reduced pressure. Liquid ring pump 354 is configured to receive distillate 18 and non-condensable gases 20 from steam condenser 267 and to provide distillate 18 at ambient pressure to distillate holding vessel 358 (e.g., distillate holding tank/reservoir, etc.). Liquid ring pump 354 includes a centrifugal pump that utilizes the incoming distillate to maintain sealing under vacuum, and includes an impeller that directs water against a housing thereof to form a compression-chamber seal that prevents loss of vacuum during operation.

In some embodiments, liquid ring pump 354 is fluidly coupled to pump heat exchanger 356 and distillate holding vessel 358 downstream from liquid ring pump 354. Pump heat exchanger 356 cools distillate from distillate holding vessel 358 as it is recirculated to liquid ring pump 354 by rejecting heat to air, which reduces the risk of cavitation of distillate within the pump housing and improves pump performance.

Among other benefits, use of liquid ring pump 354 can eliminate the need for a separate water-separator reservoir (e.g., water-separation vessel 272 of FIG. 2D) or distillate holding tank, thereby reducing the number of components of the brine concentration system.

Referring again to FIG. 2D, brine recirculation loop 255 includes various pumps and/or control valves that are configured to control the flow of the process stream (e.g., feedwater 10, heated brine mixture 24, steam 14, brine 16, distillate 18, etc.) through flash tank 256 In some embodiments, brine recirculation loop 255 includes recirculation pump 261, brine pump 276, and distillate pump 278. In other embodiments, brine recirculation loop 255 includes additional, fewer, and/or different components.

In the embodiment of FIG. 2D, recirculation pump 261 is disposed in recirculation line 22 of recirculation loop 255.

Brine pump 276 is configured to remove brine 16 from the system once the brine has achieved the desired concentration of total dissolved solids. In the embodiment of FIG. 2D, brine pump 276 is fluidly coupled to recirculation line 22 between flash tank 256 and recirculation pump 261. In other embodiments, brine pump 276 is fluidly coupled to recirculation loop 255 between recirculation pump 261 and brine heater 263.

Distillate pump 278 is configured to remove distillate 18 from water-separation vessel 272. In some embodiments, distillate pump 278 is fluidly coupled to water-separation vessel 272 at a lower end of water-separation vessel 272.

### Brine Recirculation System

Brine recirculation loop 255 is configured to recirculate a non-evaporated portion of heated brine mixture 12 back to pressure control device 252, which can increase the overall recovery ratio of brine concentration system 250. Brine recirculation loop 255 includes brine recirculation pump 261, at least one flow control valve 280, and recirculated brine monitoring device 282.

Recirculation pump 261 is configured to recirculate a non-evaporated portion of brine from flash tank 256 to pressure control device 252.

Flow control valve(s) 280 are configured to control a flow rate of concentrated brine out of brine concentration system 250 and the mixture ratio of freshwater 10 to recirculated brine. In some embodiments, flow control valve 280 is disposed in recirculation line 22 at a location between flash tank 256 and recirculation pump 261. In other embodiments, flow control valve 280 is disposed in a discharge line that is coupled to recirculation line 22 at a location between circulation pump 261 and brine heater 263. In some embodiments, flow control valve 280 is teed directly off recirculation pump 261 or the discharge line.

Recirculated brine monitoring device 282 is configured to monitor a condition of the recirculated feedwater/brine during operation and may be used to control operation of recirculation pump 261 and/or flow control valve(s) 280. In some embodiments, recirculated brine monitoring device 282 is a Coriolis flow meter that is configured to monitor a flow rate and density of the recirculated feedwater/brine. In other embodiments, recirculated brine monitoring device 282 may be another type of sensor that is configured to generate data indicative of at least one of a chemical or contaminant concentration level of the recirculated feedwater, such as conductivity or chlorinity.

In some embodiments, brine recirculation loop 255 can be operated in a “brine recirculation” mode. In other embodiments, brine recirculation loop 255 can be operated in a “once through” mode.

### Flushing System

Referring still to FIG. 2D, brine concentration system 250 also includes flushing system 251 that is configured to remove corrosive feedwater from both brine heater 263 and flash tank 256. Flushing system 251 includes flush tank 284 (e.g., flush reservoir, etc.) and at least one flush valve 286.

Flush tank 284 (e.g., flush reservoir, etc.) is configured to hold a quantity of flushing agent for use in flushing (e.g., purging) or otherwise treating internal components of the brine concentration system to thereby reduce the risk of fouling and corrosion while the system is shut down (e.g., during periods of non-operation, in applications requiring intermittent operation, etc.). In some embodiments, the flushing agent is or includes distilled water. In other embodiments, the flushing agent includes a cleaning solution (e.g., a chemical cleaning solution, etc.) to facilitate removal of feedwater from brine heater 263, brine recirculation loop 255, and/or other system components.

Flush valve(s) 286 is configured to control introduction of the flushing agent from flush tank 284. In the embodiment of FIG. 2D, flush valve 286 is located upstream of flash tank 256 and/or recirculation pump 261 and fluidly couples flush tank 284 to flash tank 256. In other embodiments, flushing system 251 includes flush valve(s) 286 disposed in other locations along the system. In some embodiments, at least one of flush valve(s) 286 is an isolation valve that allows a user to fluidly isolate various components of the brine concentration system for cleaning.

### Control System

Referring to FIG. 4, a block diagram of control system 400 that may be used for controlling operation of the brine concentration system is shown, according to an embodiment. Control system 400 is configured to control operation of one or a combination of: (i) process flow conditions through the brine concentration system, (ii) a brine recirculation system of the brine concentration system, and/or (iii) a flushing system for use with the brine concentration system. In some embodiments, control system 400 is also configured to monitor operation of the brine concentration system and to provide data indicative of a health of one or more components of the brine concentration system. Control system 400 may also provide a human-machine interface for interacting with the brine concentration system, adjusting operating conditions, and/or modifying system inputs. Control system 400 may also be configured to automatically initiate remedial action based on one or more sensed conditioned, as will be further described.

Control system 400 includes controller 402 (e.g., a control unit, a control circuit, a control module, etc.), sensor(s) 404, compressor 406, vacuum device 408, control valve(s) 410, and fluid transfer and handling equipment 412. In some embodiments, as shown in FIG. 4, control system 400 also includes battery pack 414 sized sufficiently for the brine concentration system to perform a flushing and shutdown routine in the event of power loss. In other embodiments, control system 400 may include additional, fewer, and/or different components.

Sensor(s) 404 are configured to generate sensor data indicative of operating conditions of the brine concentration system. Sensor(s) 404 may include fluid sensors that are configured to generate data indicative of conditions of the process stream passing through the brine concentration system. For example, in some embodiments sensor(s) 404 may include at least one feedwater condition sensor (shown as feedwater sensor 404 in FIG. 2D) that is configured to generate sensor data indicative of a temperature of feedwater entering the brine concentration system. Sensor(s) 404 may also include recirculated brine monitoring device 282 described with reference to FIG. 2D (e.g., the Coriolis flow meter). In yet additional embodiments, sensor(s) 404 may also include one or more sensors used to monitor operating conditions of the closed-cycle heat pump (e.g., closed-cycle heat pump 253 of FIG. 2D). In yet further embodiments, sensor(s) 404 may also include one or more electrical sensors, such as a voltage sensor to enable determination of available supply power that is being provided to the system. In yet further embodiments, sensor(s) 404 may also include one or more pressure sensors used to monitor operating conditions in flash tank 256, steam conduit 258, and steam condenser 267. In yet further embodiments, sensor(s) 404 may also include one or more water pressure sensors used to monitor water pressure in the feedwater input line, brine recirculation loop 255, between brine heater 263 and pressure control device 252, and other operating points in the system.

Compressor 406, vacuum device 408, control valve(s) 410, and fluid transfer equipment 412 may be as described with reference to FIG. 2D, and together may be used to control feedwater delivery, as well as operate one or a combination of closed-cycle heat pump 253, variable flow-rate vacuum device 254, recirculation loop 255, and flushing system 251 as described with reference to FIG. 2D.

Controller 402 is communicably coupled to sensor(s) 404, compressor 406, vacuum device 408, control valve(s) 410, and fluid transfer equipment 412 by communication interface 418. Controller 402 includes processing circuit 416 having processor 420 and memory 422. Processor 420 is configured to execute computer code or instructions stored in memory 422 or received from other computer readable media. Memory 422 may include one or more devices (e.g., memory units, memory devices, storage device, etc.) for storing data and/or computer code for completing and/or facilitating the various processes described in the present disclosure. Memory 422 may be communicably coupled to processor 420 via processing circuit 416 and may include computer code for executing one or more processes described herein.

In the embodiment of FIG. 4, communication interface 418 also enables communication with user device(s) 424 (e.g., a smartphone, a personal computer, etc.) that may be remotely located from the brine concentration system. Communication interface 418 may include a wired and/or wireless interface (e.g., Bluetooth, cellular, local area network (LAN), wide area network (WAN), near field communication, etc.) for conducting communications with user device(s) 424. For example, communication interface 418 may include a Bluetooth transceiver and/or a Wi-Fi transceiver for communication via a wireless communications network. In some embodiments, communication interface 418 is communicably coupled to user device(s) 424 through Internet 426. In such embodiments, controller 402 may be configured to communicate, via communication interface 418, with a cloud server (e.g., a third-party server, an internet of things (IoT) server, etc.), shown as database 428 to store/publish data from the brine concentration system, monitor operation of the brine concentration system, control the brine concentration system remotely, control the brine concentration system as a member of a group of two or more brine concentration systems controlled collectively via user device(s) 424 or cloud server 428, and/or to retrieve software updates to the brine concentration system.

Controller 402 may be configured to generate, or provide data necessary to generate, a graphical user interface (GUI) 430 through which a user can monitor and control the functionality of the brine concentration system. GUI 430 may include graphical indicators that provide a user with different options for selecting modes of operation, setting feedwater conditions, setting a desired recovery ratio, viewing live performance data, and/or monitoring conditions of the process stream during operation.

### Brine Concentration Method

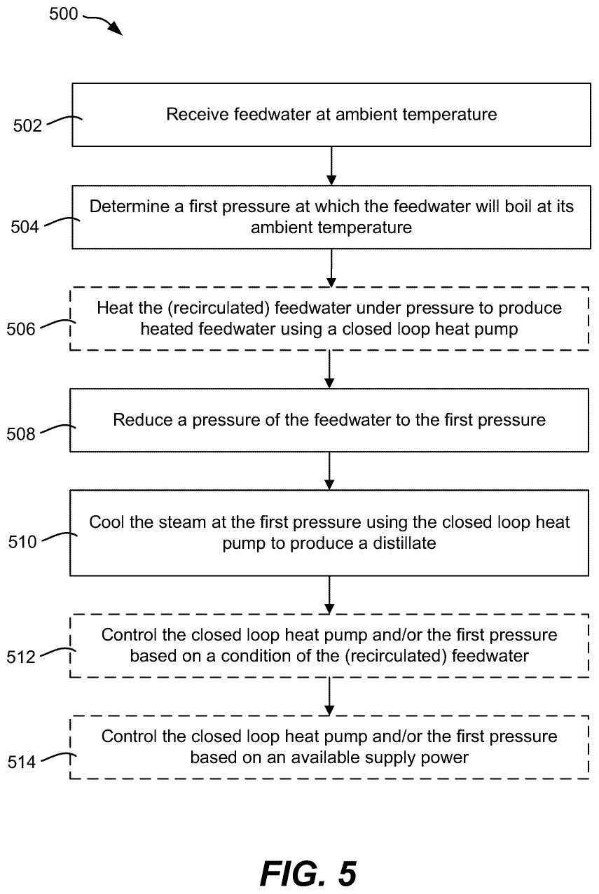

As described above, control system 400 is configured to automatically adjust operating conditions of the brine concentration system to enable different modes of operation with a wide variety of different, and variable, feedwater sources (e.g., at different temperatures, and/or including different types of contaminants, etc.). Referring to FIG. 5, method 500 of operating the brine concentration systems of the present disclosure is shown, according to an embodiment. At least portions of method 500 may be implemented by any of brine concentration systems 102 and 200 of FIGS. 2A-D and/or control system 400 of FIG. 4. For the sake of simplicity, method 500 is described with reference to the components shown in FIGS. 2D and 4.

At 502, the system receives feedwater at ambient temperature. In some embodiments, operation 502 includes receiving feedwater (e.g., a brine, or other impaired feedwater, etc.) at atmospheric pressure and at ambient temperature. Operation 502 may include determining the temperature and/or salinity of the feedwater.

At operation 504, the system determines a pressure at which the feedwater will boil at its ambient temperature and salinity, and creates a setpoint for the vacuum device (e.g., variable flow-rate vacuum device 254), which pumps the flash tank, steam conduit, and steam condenser down to the desired pressure level and maintains the system at that pressure. For example, if the feedwater is seawater at 21.1° C. (70° F.), the vacuum device runs until the flash tank, steam conduit, and steam condenser are all at 0.5 psia, or less, and maintains the pressure at or below that level. Operation 504 may include determining the pressure based on lookup tables of boiling point and/or steam density as a function of vacuum and/or ambient temperature, or by using algorithms stored in memory. In one embodiment, operation 504 comprises detecting actual boiling in the brine heater by using an acoustic sensor to detect the sound of vapor bubbles collapsing on the heat transfer surface area of the brine heater.

At optional operation 506, the system actives the refrigerant compressor of the closed-cycle heat pump to circulate refrigerant through the brine heater and steam condenser. Operation 506 may include pumping brine under pressure through a brine heater (e.g., brine heater 263).

At operation 508, the system pumps feedwater through pressure control device (e.g., an orifice or a liquid providing sufficient head to suppress flashing) into the flash tank at a reduced pressure, whereupon some portion of it flashes to steam.

In some embodiments, operation 508 also includes controlling a brine recirculation system (e.g., recirculation loop 255) to concentrate brine to a desired concentration. In some embodiments, operation 508 includes pumping, via a recirculation pump, the feedwater exiting the flash tank through a monitoring device (e.g., recirculated brine monitoring device 282), such as a Coriolis flow meter, to generate data indicative of a salinity of the brine. In such embodiments, operation 508 includes controlling a brine outlet flow, via a brine pump (e.g., brine pump 276), one or more flow control valve(s) 280, and/or feedwater mixing valves based on the salinity. In some embodiments, operation 508 includes controlling the recirculation system based on an algorithm in memory or a lookup table including a list of recirculation rates and/or ratios as a function of the salinity of the feedwater.

In some embodiments, operation 508 includes controlling the recirculation system to achieve a salinity approximating a saturation point of sodium chloride in water and/or to achieve a recovery ratio (defined as the ratio of the volumetric rate of distillate to the volumetric rate of feedwater passing through the brine concentration system) of 65%, 70%, 75%, 80%, 85%, or greater, or a range between and including any two of the foregoing values.

In some embodiments, operation 508 includes controlling the brine recirculation system to achieve a salinity approximating the desired recovery ratio set by a user.

In other embodiments, operation 508 includes controlling the brine recirculation system to operate in a “once through” mode.

At 510, the system cools the steam generated by the vacuum system. Operation 510 includes cooling the steam at reduced pressure by passing the steam through steam condenser 267 to produce distillate (e.g., fresh, potable water). In some embodiments, operation 510 includes passing the steam through a conduit (e.g., steam conduit 258) extending between the flash tank and the steam condenser.

In some embodiments, operation 510 includes operating a vacuum device downstream of the steam condenser to maintain the flash tank, steam conduit, and steam condenser at or below the desired pressure. The vacuum device may be coupled to an upper end of the water separation vessel downstream of the evaporator to thereby limit the amount of steam entering the vacuum device. In other embodiments, operation 510 includes passing both distillate and non-condensable gasses through a liquid ring pump (e.g., liquid ring pump 354) disposed downstream of the evaporator to maintain the process stream at reduced pressure.

At 512, the system (e.g., controller 402) controls the reduced pressure in the vacuum system based on a temperature of the feedwater being supplied to the system. In some embodiments, operation 512 includes measuring the temperature of feedwater by a sensor(s) (e.g., sensor(s) 404, inlet feedwater sensor, etc.) disposed along an inlet conduit of the system. Operation 512 includes controlling one, or a combination of, a variable flow rate compressor of the closed-cycle heat pump and the variable flow rate vacuum device based on the temperature. For example, operation 512 may include increasing vacuum and/or adding more heat by running the refrigerant compressor at higher speeds in response to colder ambient feedwater temperatures. In some embodiments, operation 512 also includes controlling a mixing valve of the closed-cycle heat pump to reduce an amount of heat provided to the feedwater in the brine heater. In some embodiments, the system controls the rate of heat transfer between the brine heater and the steam condenser based on a desired feedwater flowrate or distillate flowrate by operating the refrigerant compressor faster or slower.

At 514, the system controls the closed-cycle heat pump and/or the vacuum system based on an available supply power. Operation 514 includes receiving, by a controller (e.g., controller 402), sensor data indicative of the available supply power (e.g., a supply voltage, etc.). Operation 514 includes increasing or decreasing throughput of feedwater and/or power consumption based on the available supply power. For example, operation 514 may include reducing a speed of the recirculation pump, the variable flow rate compressor, and/or lowering the recovery ratio in response to an indication that the available supply power has decreased, to thereby enable continuous production of desalinated water even in low/decreased power applications.

In some embodiments, operation 514 includes automatically activating a flushing system (e.g., flushing system 251) in response to a determination that the available power is less than a power threshold required to continue operation of the brine concentration system (e.g., in response to losing external power). In such embodiments, operation 514 includes powering down the variable flow rate compressor and/or recirculation pump to reduce energy consumption of the brine concentration system. In some embodiments, operation 514 includes maintaining operation of the variable flow rate vacuum device or reducing pump speed/capacity to maintain rough vacuum across the vacuum system, and thereby reduce the risk of oxygen-driven fouling and corrosion during periods of non-operation. In other embodiments, operation 514 includes activating one or more shutoff or isolation valves before shutting down the vacuum device to maintain rough vacuum in at least portions of the vacuum system.

In yet other embodiments, operation 514 includes activating a flush valve (e.g., flush valve 286) to automatically flush and/or purge at least a portion of the brine concentration system with a flushing agent. For example, operation 514 may include activating the flush valve to flush at least the feedwater side of the brine heater with the flushing agent to remove at least a portion of the feedwater from the heat transfer surface, or to otherwise dilute feedwater and thereby reduce the likelihood of fouling and corrosion. In some embodiments, operation 514 includes pumping the flushing agent through other parts of the brine concentration system, such as the flash tank, to flush or otherwise treat surfaces in contact with the feedwater.

The embodiments of the brine concentration system described with respect to FIGS. 1-3 are provided as illustrative examples of arrangements enabling brine concentration across a wide variety of applications and feedwater conditions. It should be appreciated that many variations and alterations of the brine concentration system are possible without departing from the inventive principles disclosed herein.

For example, although FIGS. 1-3 have been depicted and described as single-stage systems, a person of ordinary skill in the art would understand that the ULTD process disclosed herein may be implemented with multiple stages, e.g., in a heat-pump-driven multi-stage flash (MSF) system or in a heat-pump-driven multiple effect desalination (MED) system.

### Process Models

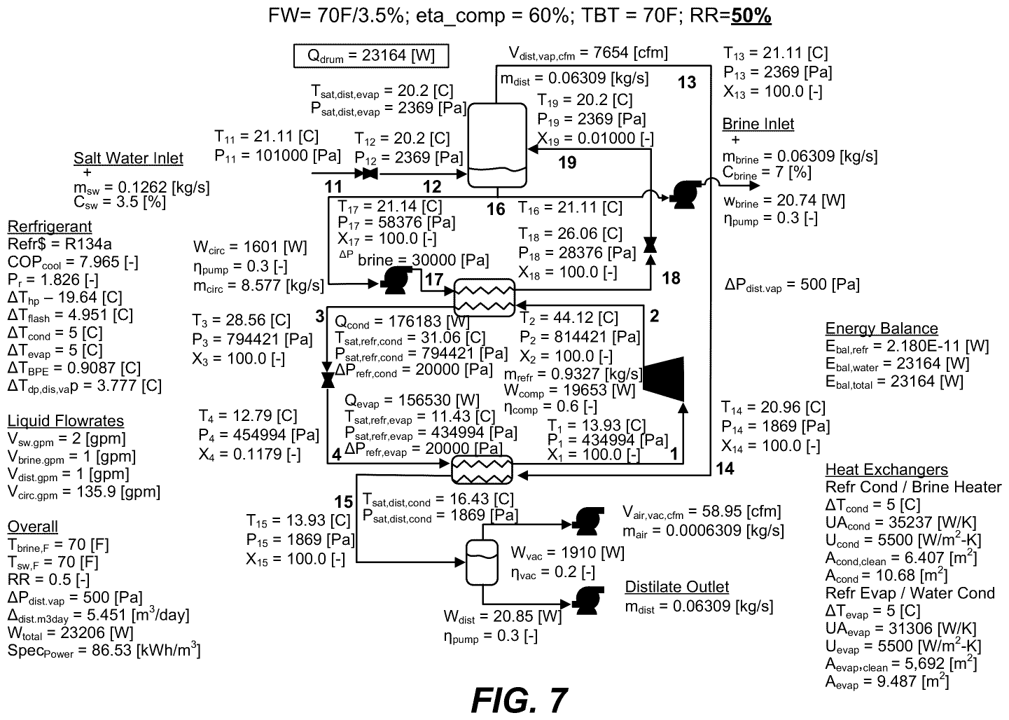

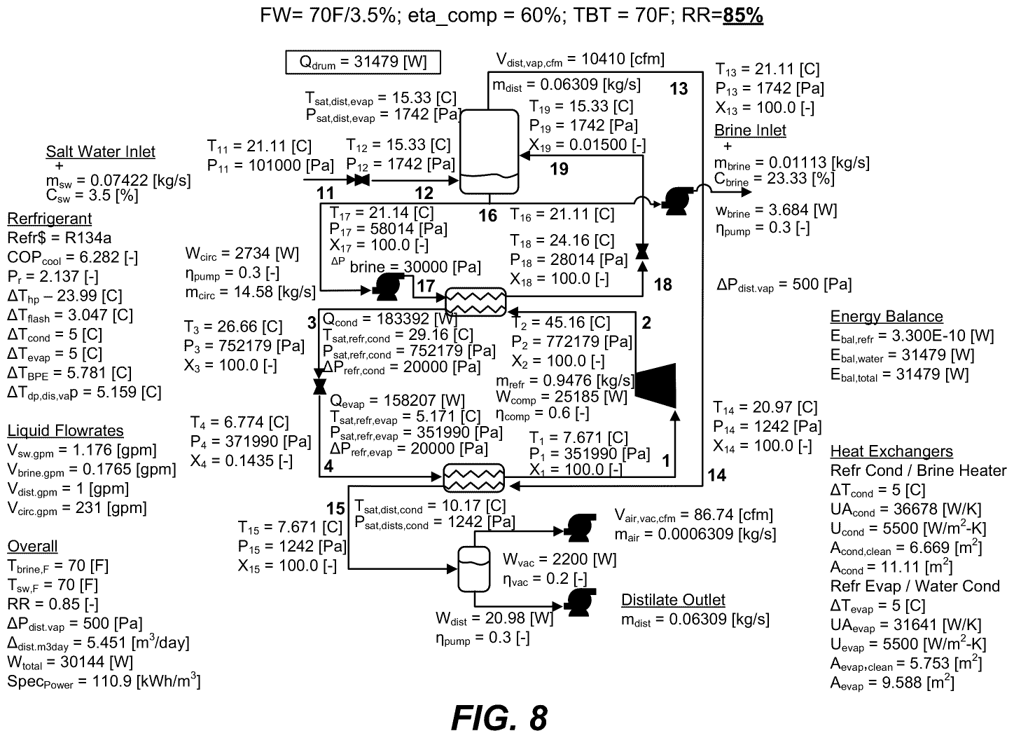

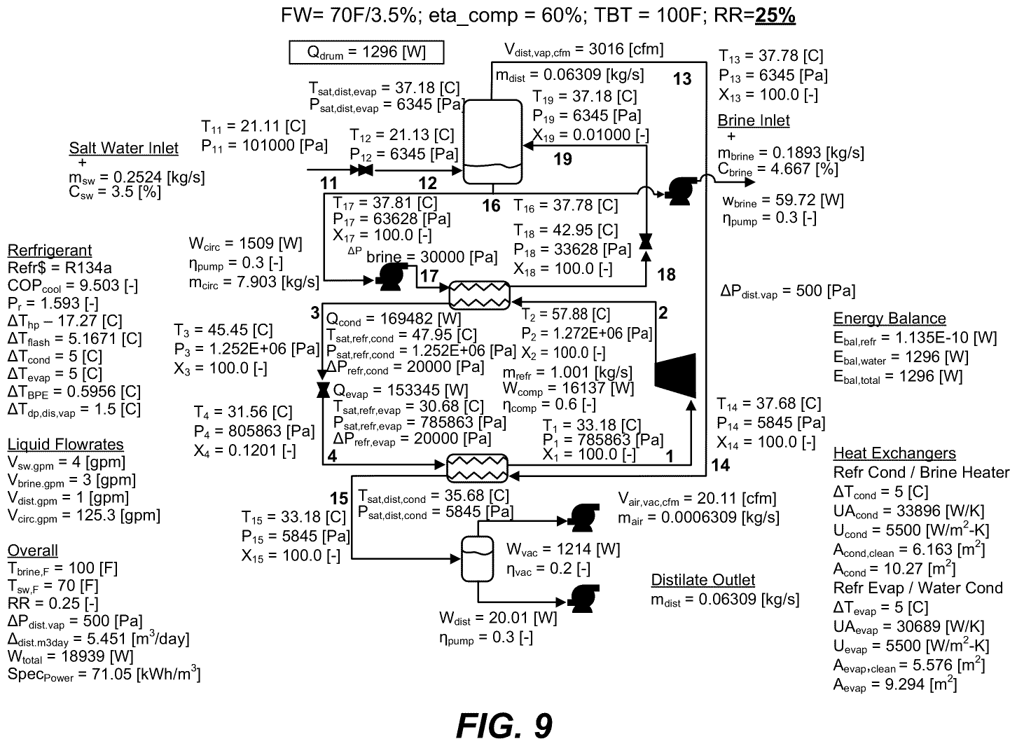

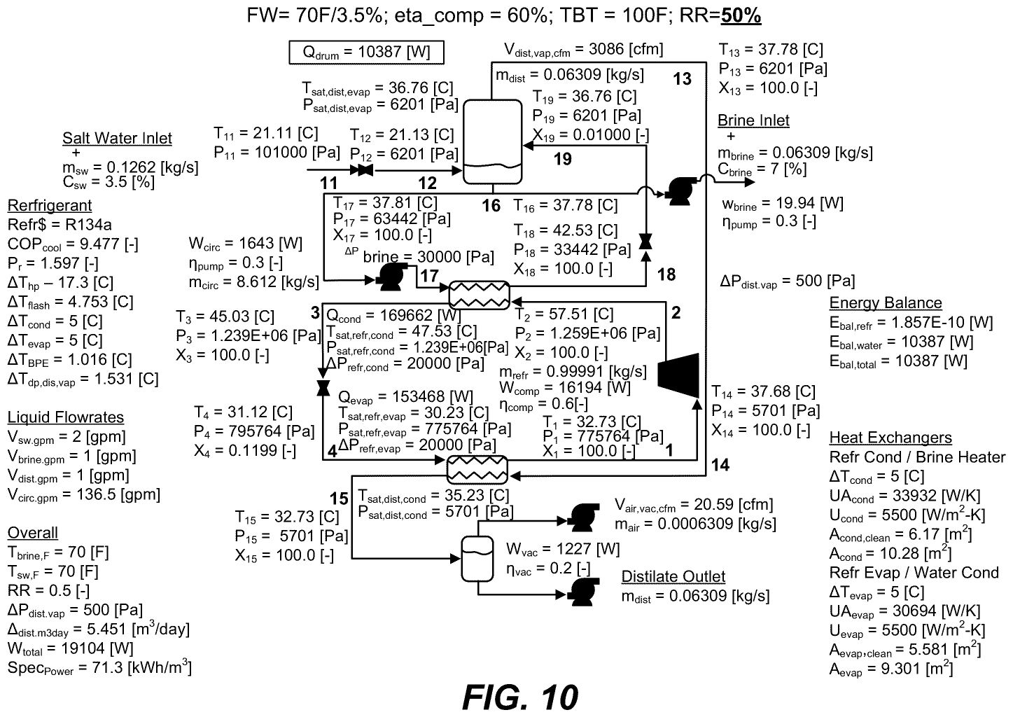

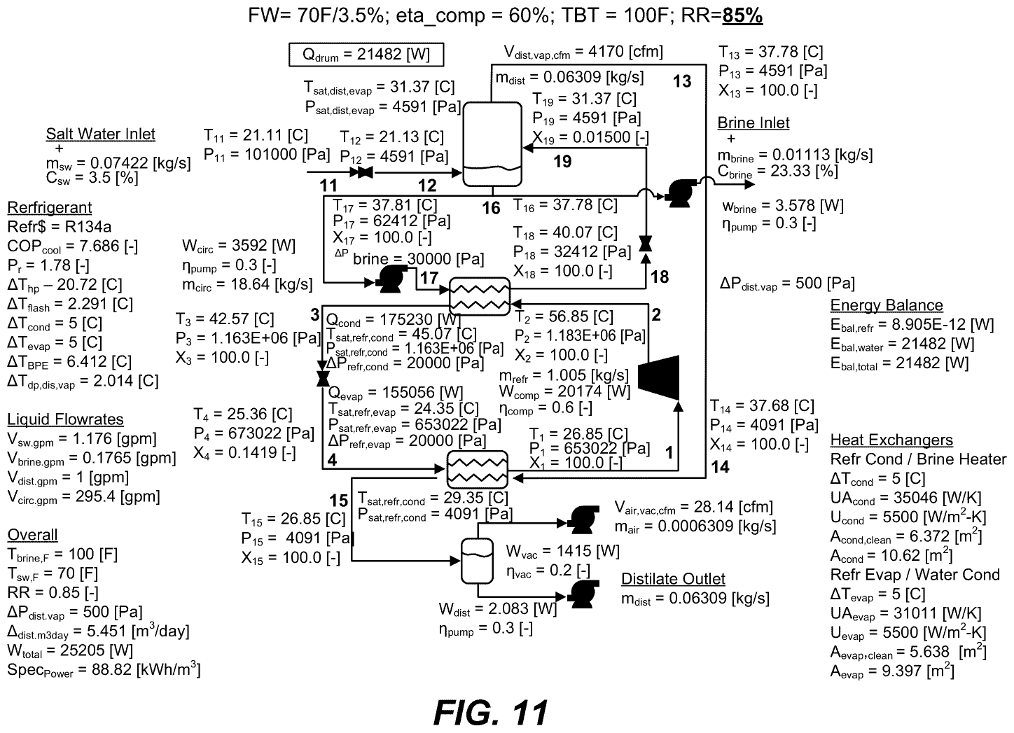

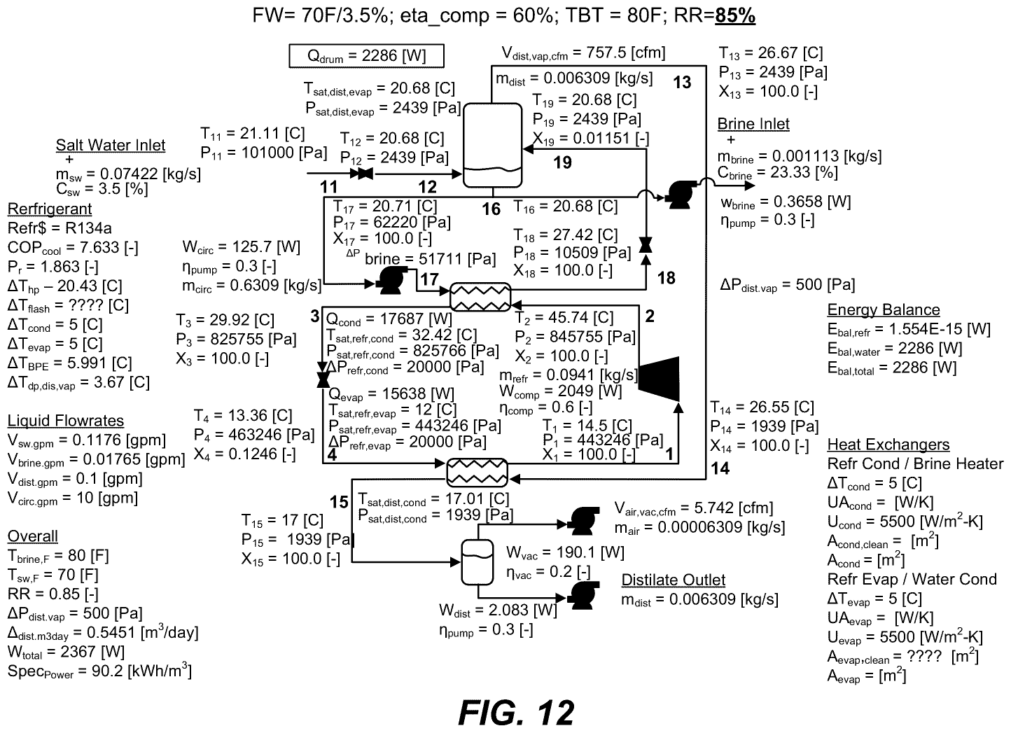

FIGS. 6-12 depict process parameters for an embodiment of the present disclosure operating under different process conditions. FIG. 6 depicts the embodiment operating with incoming feedwater at 70° F., a TBT of 70° F., and a recovery rate of 25%. FIG. 7 depicts the embodiment operating with incoming feedwater at 70° F., a TBT of 70° F., and a recovery rate of 50%. FIG. 8 depicts the embodiment operating with incoming feedwater at 70° F., a TBT of 70° F., and a recovery rate of 85%. FIG. 9 the embodiment operating with incoming feedwater at 70° F., a TBT of 110° F., and a recovery rate of 25%. FIG. 10 depicts the embodiment operating with incoming feedwater at 70° F., a TBT of 110° F., and a recovery rate of 50%. FIG. 11 depicts the embodiment operating with incoming feedwater at 70° F., a TBT of 110° F., and a recovery rate of 85%. FIG. 12 depicts the embodiment operating with incoming feedwater at 70° F., a TBT of 80° F., and a recovery rate of 85%.

### Methods of Operation

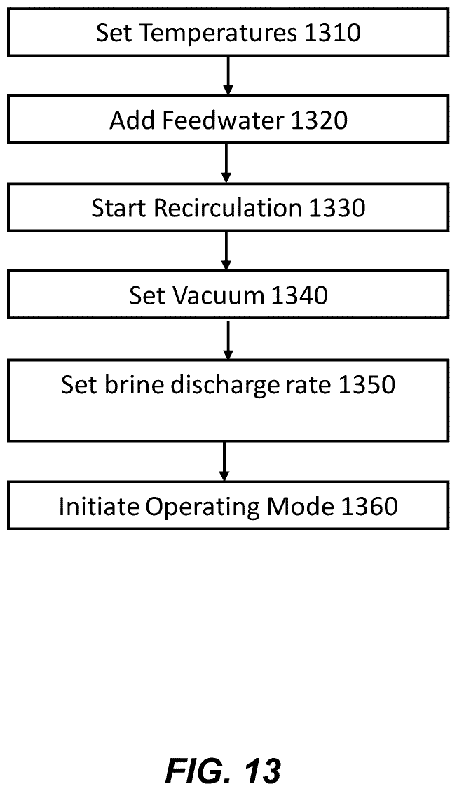

FIG. 13 through FIG. 18 are flowcharts depicting various operations of brine concentration system 110, in accordance with some embodiments. In various embodiments, the operations may include different, fewer, or additional steps than those described in conjunction with the flowcharts. Further, in some embodiments, the steps in the processes may be performed in different orders than the order described in conjunction with FIG. 6. The processes may be controlled by controller 120 that provides command signals to brine concentration system 110, although in some embodiments controller 120 is part of brine concentration system 110. In some embodiments, one of the steps may be performed automatically by controller 120 or manually through an operator providing inputs to controller 120.

FIG. 13 depicts a flowchart illustrating an operation corresponding to a startup procedure of brine concentration system 110, in accordance with an embodiment. Controller 120 generates a command to set 1310 the temperatures of brine concentration system 110. The temperatures may include various temperatures of components discussed in this disclosure, such as the temperature at brine heater 208. By way of example, controller 120 may control compressor 222 to regulate the temperature of the cool refrigerant. The cool refrigerant performs heat exchange with brine heater 208 to set the temperature at brine heater 208. Brine heater 208 may include a temperature sensor to provide feedback to controller 120 to control the pressure setting of compressor 222.

Controller 120 sends a command to control a valve of brine concentration system 110 to open a valve or turn on a feedwater pump to add 1320 feedwater to mix with the existing brine at brine heater 208. Controller 120 sends a command to turn on brine recirculation pump 106 to start 1330 the recirculation of the brine mixed with the feedwater. Controller 120 sends a command to vacuum device 212 to set 1340 vacuum of brine concentration system 110. Vacuum device 212 regulates the pressure of various components that include the feedwater and the steam extracted from the feedwater, such as steam condenser 211 and brine heater 208. The relationships between the pressure values and the temperature values in various components are illustrated in FIG. 7 through FIG. 13. Controller 120 sends a command to control brine pump 276 to set 1350 the brine discharge rate. In some embodiments, brine concentration system 110 is a multi-mode system. Controller 120 may select one of the modes and initiate 1360 an operating mode.

Various parameters in brine concentration system 110, such as the temperature, the compressor level, the recirculation rate, the vacuum level that affects the pressure of the system, the discharge rate, may be controlled based on one or more criteria such as the target recovery rate, the power consumption target, the energy cost, and the operating mode. Controller 120 may determine the target values of those parameters based on the criteria and continue to receive sensor feedback readings, such as temperature readings, pressure readings, salinity readings, and flow rate readings to dynamically adjust or maintain various parameters in brine concentration system 110 to achieve a target recovery rate.

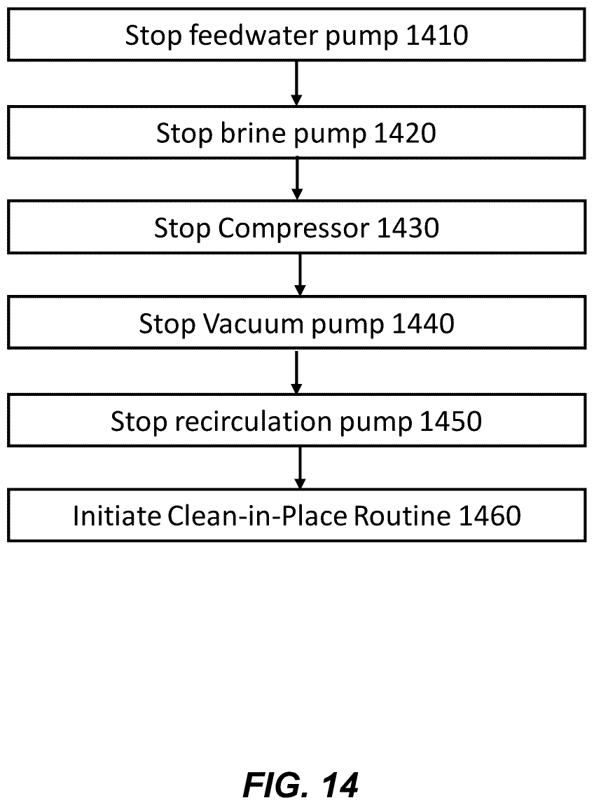

FIG. 14 depicts a flowchart illustrating an operation corresponding to a shutdown procedure of brine concentration system 110, in accordance with an embodiment. Controller 120 generates a command to stop 1410 the feedwater pump from inputting additional feedwater into brine concentration system 110. Controller 120 generates a command to stop 1420 brine pump 276 from discharging brine. Controller 120 generates a command to stop 1430 compressor 222 and another command to stop 1440 vacuum pump 1440. Controller 120 generates a command to stop 1450 recirculation pump 1450. A clean-in-place routine may be initiated 1460 to clean brine concentration system 110.

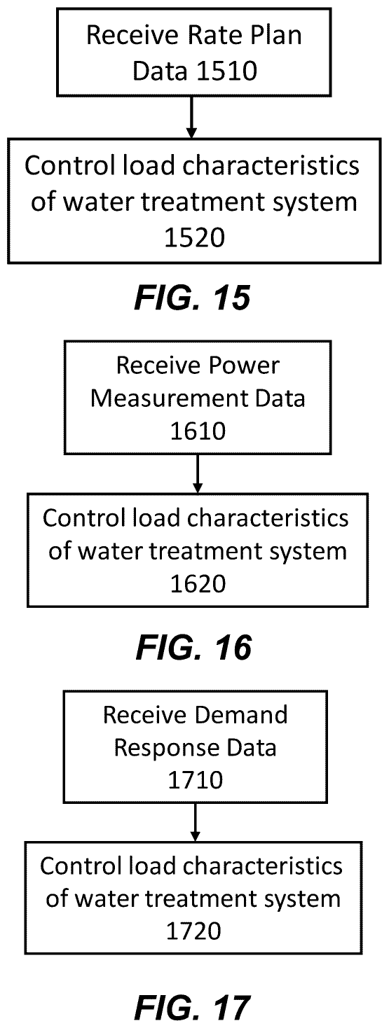

FIG. 15 depicts a flowchart illustrating an operation corresponding to a time-of-use operating mode, in accordance with some embodiments. Controller 120 receives 1510 rate plan data from utility grid 130 that supplies the power to brine concentration system 110. Controller 120 generates one or more commands to control 1520 load characteristics of brine concentration system 110 based on the rate plan data. The load characteristics may be controlled by the operating levels of various components of brine concentration system 110, such as compressor 222, vacuum device 212, and brine recirculation pump 206. Controller 120 may adjust the target recovery rate, which in turn may affect the pressure and temperature of various components in brine concentration system 110. In some situations, based on the rate plan data, controller 120 may completely shut off brine concentration system 110. In some situations, based on the rate plan data, controller 120 may reduce the operation levels of compressor 222 and vacuum device 212 at certain time periods of the day to reduce power usage.

FIG. 16 depicts a flowchart illustrating an operation corresponding to an available-power operating mode, in accordance with some embodiments. Controller 120 receives 1610 power measurement data by determining the power that is available for the consumption of one or more brine concentration systems 110. For example, in some embodiments, brine concentration systems 110 may be powered by a battery energy storage system, which store energy delivered from utility grid 130. Depending on the energy remaining in the power storage system, controller 120 generates one or more commands to control 1620 load characteristics of brine concentration system 110. The load characteristics may be controlled by the operating levels of various components of the brine concentration system 110, such as compressor 222, vacuum device 212, and brine recirculation pump 206. Controller 120 may adjust the target recovery rate, which in turn may affect the pressure and temperature of various components in brine concentration system 110. In some situations, based on the power measurement data, controller 120 may completely shut off brine concentration system 110. In some situations, based on the power measurement data, controller 120 may reduce the operation levels of compressor 222 and vacuum device 212 at certain time periods of the day to reduce power usage.

FIG. 17 depicts a flowchart illustrating an operation corresponding to a demand-response operating mode, in accordance with some embodiments. Controller 120 receives 1710 demand response data from utility grid 130, which may specify the change in the power consumption of the grid and throttling requirements. Based on the demand response data, controller 120 generates one or more commands to control 1720 load characteristics of brine concentration system 110. The load characteristics may be controlled by the operating levels of various components of brine concentration system 110, such as compressor 222, vacuum device 212, and brine recirculation pump 206. Controller 120 may adjust the target recovery rate, which in turn may affect the pressure and temperature of various components in brine concentration system 110. In some situations, based on the demand response data, controller 120 may completely shut off brine concentration system 110. In some situations, based on the demand response data, controller 120 may reduce the operation levels of compressor 222 and vacuum device 212 at certain time periods of the day to reduce power usage.

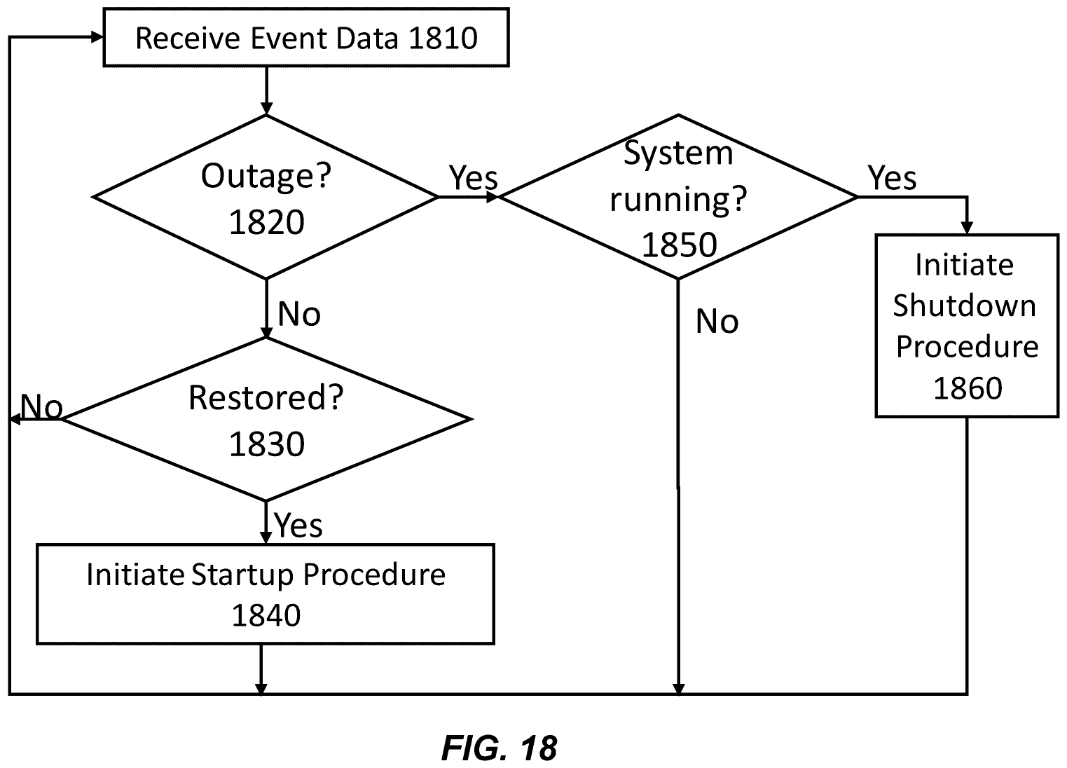

FIG. 18 depicts a flowchart illustrating an operation corresponding to an outage recovery procedure, in accordance with some embodiments. Controller 120 receives 1810 event data related to brine concentration system 110. For example, the event data may include power data from utility grid 130 or battery data if one or more brine concentration systems 110 are powered by a battery system. In addition, the event data may include readings from various sensors, such as the temperature, pressure, and flowrate readings. Controller 120 determines 1820 whether there is an outage based on the event data, such as based on the power data or battery data. If controller 120 determines that there is no longer a power outage, controller 120 determines 1830 whether it should restore brine concentration system 110. If controller 120 determines 1830 that it should not be restoring brine concentration system 110, controller 120 continues to receive 1810 event data until restoration is appropriate. If controller 120 determines 1830 that it should restore brine concentration system 110, controller 120 generates one or more commands to initial 1840 a startup procedure that is depicted in FIG. 13. Referring to block 1820, if controller 120 determines 1820 that there is an outage, controller 120 determines 1850 whether brine concentration system 110 is still operating based on the sensor readings of brine concentration system 110. If the system is already shut down, controller 120 continues to receive 1810 event data until the outage ends and brine concentration system 110 is ready to be restored. If controller 120 determines that one or more components in brine concentration system 110 are still running in the event of an outage, controller 120 initiates 1860 a shutdown procedure that is depicted in FIG. 14.

### Utility Grid Interface

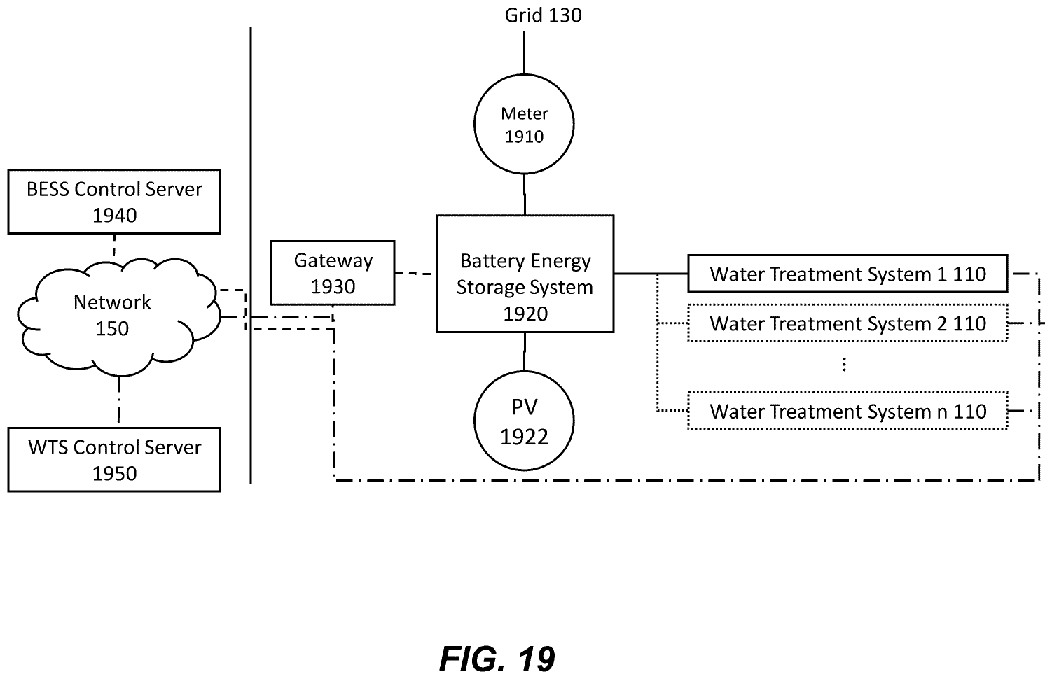

FIG. 19 is a block diagram illustrating the architecture of grid interface 1900, in accordance with some embodiments. Grid interface 1900 may be used to power one or more brine concentration systems 110. Grid interface 1900 may include meter 1910 that is connected to utility grid 130, battery energy storage system 1920 and PV system 1922 that may be used to convert solar power to battery energy to be stored in battery energy storage system 1920, gateway 1930, battery energy storage system (BESS) control server 1940, and a water treatment system (WTS) control server 1950 that are in communication with gateway 1930 through network 150. Gateway 1930 may be an example of controller 120 that is used to control battery energy storage system 1920 and one or more brine concentration systems 110 based on the data and control information provided by BESS control server 1940 and WTS control server 1950.

### Experimental Result and Data

Carnot simulated concentration of a range of feedwaters-brackish RO concentrate, produced water, lithium brine, FGD blowdown under ULTD process conditions at ˜80 F (27° C.) and 0.5 psia to predict the chemical speciation; in particular, what species will precipitate out at increasing concentration.

Brackish water RO projects. Carnot obtained analyses of concentrates from five brackish water RO projects that desalt groundwater, secondary effluent, seawater-influenced brackish groundwater and, in one case, a mixture of all three. The concentrates range from 3,600 to 23,000 mg/L TDS, pH of 7.8-9.8, mainly NaCl and Na₂SO₄ with high levels of calcium, magnesium, silica, and bicarbonate alkalinity, and with trace amounts of ammonia, barium, boron, fluoride, nitrate, potassium, and strontium.

Under ULTD conditions, relatively large amounts of calcium carbonate (CaCO₃) will precipitate from these brines, and, given its low and inverse solubility, our experience is that CaCO₃ is likely to precipitate on the main ULTD brine heater despite the low brine boiling temperature of 80-100° F. (27-38° C.) in the preferred operating mode. Acidifying the feed brine to pH 5.5 will convert the bicarbonate to CO₂, which will be removed by the ULTD vacuum pump, eliminating the scaling potential in the ULTD.

These RO concentrates can then be concentrated in the ULTD to recover a minimum of 85% of the water, limited only by the solubility limits of barium, strontium, and fluoride salts. The boiling point elevation at 85% recovery is low, ranging from 1-5° F.

Calcium sulfate (CaSO₄) and silica (SiO₂) will also precipitate, but our experience is that in the forced circulation design used for the ULTD, tiny crystals of these two salts will “seed” the circulating brine and the two salts will co-precipitate preferentially on the seed crystals, rather than on the heat transfer surfaces as scale. This phenomenon of “seeding” a brine to prevent scaling is a well-established and documented feature of evaporator/crystallizer design and has been proven commercially for decades. In the ULTD system design, seeding should occur naturally and the system will operate continually with little or no scaling at high water recovery.

Produced Water from conventional and enhanced oil and gas extraction methods. These brines vary greatly in composition depending on the location of the drill sites and the type of extraction method employed. Carnot obtained an analysis of a produced water sample from a California oilfield which uses steam injection into the formation to enhance extraction of crude oil. The sample was taken post-treatment to remove any hydrocarbons to very low levels.

The TDS was 8,880 mg/L, pH of 8.7 and the composition was mainly NaCl with very small amounts of aluminum, boron, calcium, lithium, magnesium, potassium, silica, sulfate, and bicarbonate alkalinity. There were also trace amounts of many metals present, typically in concentrations less than 0.01 mg/L, and trace amounts of several hydrocarbons, such as benzene, toluene, and xylene and C₁₀ to C₃₄ hydrocarbons.

Simulation under ULTD conditions predict formation of several carbonate scales, including CaCO₃, due to the bicarbonate alkalinity in the produced water, but also confirmed that acidification of the raw produced water to a pH of 5.5 converted the bicarbonate to CO₂ This produced water can be concentrated to recover at least 75% of the water under ULTD conditions. Relatively large amounts of several sodium aluminum silicate salts are predicted to precipitate above 75% water recovery, which may present a scaling risk.

One interesting result was that there was enough lithium (˜6 mg/L as Li⁺¹) and magnesium (˜23 mg/L as Mg⁺²) present in the concentrated produced water to consider recovering these strategic metals. The presence of significant amounts of boron may complicate efforts to recover relatively pure lithium and magnesium brines.

Lithium brines. The current estimated lithium resources in continental/salar brines is approximately 52.3 million tonnes of lithium equivalent, mostly in Chile, Argentina and Bolivia, of which 23.2 million tonnes is estimated to be recoverable. Up till now lithium has been mostly produced from salar brines which contain 0.06-0.15% Li due to the lower cost of production compared to hard rock mining of ores containing lithium salts.

Carnot obtained simplified analyses (Na, K, Ca, Mg, Li, B, Cl, SO4) of several different salar brines currently being exploited for lithium and typical by-products such as boric acid, potash, sylvite (KCl), and sylvinite (KCl·NaCl). These brines are high in TDS, ranging from 20-33% TDS, and are strong sodium chloride solutions (15-25% by weight). Boiling temperatures of these brines at the ULTD operating pressure of 0.5 psia ranged from 85° F. to over 100° F.

Since the normal operating temperature in the ULTD is not much different from the solar evaporation ponds which have traditionally been utilized to concentrate brines to produce lithium and other valuable by-products, we expected the chemistry results from our simulations to be similar to the well-documented chemistry in solar evaporation ponds.

In salar brines containing Mg, carnallite (KCl·MgCl₂·6H₂O) or bischofite (MgCl₂·6H₂O) starts precipitating when the brine is concentrated to ˜4.4% Li. The solar evaporation reaches 5.5-6.5% Li before the concentrated brine is processed to recover lithium as lithium carbonate or chloride. By then lithium carnallite, LiCl·MgCl₂·6H₂O, also precipitates thus reducing the lithium recovery from the process. The brine by then will contain ˜6% Li, 1-4% Mg, 0.5-1% boron (as borate). The separate recovery of Mg is therefore necessary for the production of high purity lithium carbonate or lithium chloride. Boron (B) is also recovered, as apart from improving the process economics, its removal from the concentrated brine is essential for the production of low B feedstock required for advanced battery manufacturing or Li metal production.

The simulation predictions under ULTD conditions did, in fact, correlate closely with what has been published in the literature about the solubilities of the various species in solar evaporation ponds.

Because the solar evaporation process is so slow, the ULTD process could be a game-changing technology in the processing of salar brines to produce lithium. The ULTD requires no utilities to operate other than electric power, so it is amenable to being utilized to concentrate suitable salar brines at their source (typically desert areas) using electric power generated from solar panels. The environmental impacts of traditional evaporation ponds can be eliminated and the production rate of concentrated brines can be greatly increased. The recovered water from brine evaporation in a ULTD would be valuable in the arid areas where salar brines are found.

FGD Wastewater. In 2024 the U.S. Environmental Protection Agency published new Effluent Limit Guidelines for coal-fired power plants which employ Flue Gas Desulfurization (FGD) scrubbers to remove polluting sulfur dioxide gas from smokestack emissions. These scrubbers use water-based slurries of lime or limestone to react with SO₂ and remove it as insoluble gypsum, CaSO₄·2H₂O, which is often used to make wallboard and other useful products. The wastewater from the FGD scrubbing process contains calcium, magnesium, sodium, chloride and sulfate and also contains other pollutants removed from the flue gas, including trace amounts of environmentally hazardous metals such as arsenic, mercury, selenium, and nitrates/nitrites. The new EPA rules require zero liquid discharge (ZLD) for FGD wastewater.

The conventional ZLD process for FGD wastewater utilizes lime-soda (Ca(OH)₂ and Na₂CO₃) softening of the FGD wastewater prior to evaporation to remove Ca and Mg from the wastewater as insoluble CaCO₃ and Mg(OH)₂, and replacing them with Na. The solution to be evaporated is then mainly dissolved NaCl and Na₂SO₄ which can be concentrated and the salts crystallized out in a thermal evaporator-crystallizer.

The ULTD systems described herein can be used as a crystallizer to simplify the ZLD process by eliminating the lime-soda softening step and evaporating the FGD wastewater under vacuum at low temperature. The calcium and magnesium are removed in the ULTD by precipitating as low solubility hydrated and double salts such as calcium chloride dihydrate (CaCl₂·2H₂O), epsom salt (MgSO₄·7H₂O), bischofite (MgCl₂·6H₂O), tachyhydrite (CaCl₂O·2MgCl₂O·2H2O), and carnallite (KMgCl₃·6H₂O).

Carnot obtained an analysis of FGD wastewater from a power plant and simulated concentration under ULTD conditions to determine if the FGD wastewater chemistry using the operating conditions of the ULTD would indicate that softening pretreatment would not be required. This wastewater is somewhat unusual in that the plant uses dolomitic lime as the reagent in their scrubber, instead of limestone. The wastewater thus has a very high Mg concentration in relation to Ca.

The simulation results showed that Ca is removed in the ULTD as gypsum, CaSO₄·2H₂O, and the Mg is removed as Epsom salt, MgSO₄·7H₂O, so no softening is required.

### Additional Considerations

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, orientations, etc.) without materially departing from the novel teachings and advantages of the subject matter described herein. Other substitutions, modifications, changes and omissions may also be made in the design, operating conditions and arrangement of the various exemplary embodiments without departing from the scope of the embodiments described herein.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the brine concentration system as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. A brine concentration system comprising:
a brine heater configured to receive brine and heat the brine;
a flash tank configured to receive the heated brine through a pressure control device to evaporate a first portion of the heated brine into steam, and to collect a second portion of the heated brine;
a steam condenser configured to receive the steam from the flash tank and condense the steam to recover distilled water;
a closed-cycle heat pump in heat exchange with the brine heater and with the steam condenser, the closed-cycle heat pump comprising:
a hot zone operating at a first temperature range, the hot zone in heat exchange with the brine heater to heat the brine, and
a cold zone operating at a second temperature range lower than the first temperature range, the cold zone in heat exchange with the steam condenser that receives the steam to condense the steam to distilled water;
a refrigerant compressor configured to compress a refrigerant to raise the temperature of the hot zone to the first temperature range;
an electric vacuum pump in connection with the flash tank and the steam condenser, the electric vacuum pump configured to reduce a pressure at the steam condenser and the flash tank to reduce a boiling point of the brine; and
a controller in communication with the closed-cycle heat pump and/or the electric vacuum pump to dynamically adjust operations of the closed-cycle heat pump and/or the electric vacuum pump.

2. The system of claim 1, wherein a difference between the first temperature range and the second temperature range is within 10 degrees Celsius.

3. The system of claim 1, wherein the controller is configured to adjust the operations of the closed-cycle heat pump and/or the vacuum pump based on power rate plan data, power measurement data, and/or demand response data.

4. The system of claim 1, wherein the controller comprises one or more processors and memory configured to store code comprising instructions, wherein the instructions, when executed by the one or more processors, cause the one or more processors to:
receive power rate data that indicates a power rate for a period is above a threshold; and
responsive to the power rate for the period being above the threshold, reduce at least one of the speed of the refrigerant compressor and the speed of the vacuum pump during the period.

5. The system of claim 1, wherein the controller comprises one or more processors and memory configured to store code comprising instructions, wherein the instructions, when executed by the one or more processors, cause the one or more processors to:
monitor one or more parameters comprising incoming brine salinity, brine recirculation salinity or available power; and
adjust one or more operating levels, the one or more operating levels comprises flowrates, vacuum level, or brine temperature.

6. The system of claim 1, further comprising one or more sensors installed at: the closed-cycle heat pump, the brine heater, and/or the steam condenser, wherein the controller comprises one or more processors and memory configured to store code comprising instructions, wherein the instructions, when executed by the one or more processors, cause the one or more processors to:
determine a recovery rate of recovering the distilled water from the brine;
receive one or more readings from the one or more sensors; and
responsive to the one or more readings, adjust at least one of the speed of the refrigerant compressor and the speed of the vacuum pump to target the recovery rate.

7. The system of claim 1, wherein the heat pump is a variable-speed compressor and the vacuum pump is a variable-speed vacuum pump.

8. A brine concentration system comprising:
a brine heater configured to receive brine and heat the brine;
a flash tank configured to receive the heated brine through a pressure control device, to evaporate a first portion of the heated brine into steam, and to collect a second portion of the heated brine;
a steam condenser configured to receive the steam from the flash tank and condense the steam to recover distilled water;
a water-to-water heat pump in heat exchange with the brine heater via a circulating warm-water loop and in heat exchange with the steam condenser via a circulating cold-water loop;
an electric vacuum pump in connection with the flash tank and the steam condenser, the electric vacuum pump configured to reduce a pressure at the steam condenser and the flash tank to reduce a boiling point of the brine; and
a controller in communication with the water-to-water heat pump and/or the electric vacuum pump to dynamically adjust operations of the water-to-water heat pump and/or the electric vacuum pump.

9. The system of claim 8, wherein the water-to-water heat pump is connected to a plurality of brine heaters.

10. The system of claim 8, wherein the controller is configured to adjust the operations of the water-to-water heat pump and/or the vacuum pump based on power rate plan data, power measurement data, and/or demand response data.

11. The system of claim 8, wherein the controller comprises one or more processors and memory configured to store code comprising instructions, wherein the instructions, when executed by the one or more processors, cause the one or more processors to:
receive power rate data that indicates a power rate for a period is above a threshold; and
responsive to the power rate for the period being above the threshold, reduce at least one of the speed of a refrigerant compressor in the water-to-water heat pump and the speed of the vacuum pump during the period.

12. The system of claim 8, wherein the controller comprises one or more processors and memory configured to store code comprising instructions, wherein the instructions, when executed by the one or more processors, cause the one or more processors to:
monitor one or more parameters comprising incoming brine salinity, brine recirculation salinity or available power; and
adjust one or more operating levels, the one or more operating levels comprises flowrates, vacuum level, or brine temperature.

13. A method for operating a brine concentration system, the method comprising:
receiving, at a brine heater, brine;
heating the brine;
receiving, at a flash tank, the heated brine through a pressure control device;
evaporating a first portion of the heated brine into steam;
collecting a second portion of the heated brine;
receiving, at a steam condenser, the steam from the flash tank and condensing the steam to recover distilled water, wherein the steam condenser and the brine heater are in heat exchange with a closed-cycle heat pump, the closed-cycle heat pump comprising:
a hot zone operating at a first temperature range, the hot zone in heat exchange with the brine heater to heat the brine, and
a cold zone operating at a second temperature range lower than the first temperature range, the cold zone in heat exchange with the steam condenser that receives the steam to condense the steam to the distilled water;
a refrigerant compressor configured to compress a refrigerant to raise the temperature of the hot zone to the first temperature range;
reducing, by an electric vacuum pump in connection with the flash tank and the steam condenser, a pressure at the steam condenser and the flash tank to reduce a boiling point of the brine; and
dynamically adjusting, by a controller in communication with the closed-cycle heat pump and/or the electric vacuum pump, operations of the closed-cycle heat pump and/or the electric vacuum pump.

14. The method of claim 13, wherein a difference between the first temperature range and the second temperature range is within 10 degrees Celsius.

15. The method of claim 13, wherein adjusting the operations of the heat pump and/or the vacuum pump is based on power rate plan data, power measurement data, and/or demand response data.

16. The method of claim 13, further comprising:
receiving power rate data that indicates a power rate for a period is above a threshold; and
responsive to the power rate for the period being above the threshold, reducing at least one of the speed of the refrigerant compressor and the speed of the vacuum pump during the period.

17. The method of claim 13, further comprising:
monitoring one or more parameters comprising incoming brine salinity, brine recirculation salinity or available power; and
adjusting one or more operating levels, the one or more operating levels comprises flowrates, vacuum level, or brine temperature.

18. The method of claim 13, further comprising:
determining a recovery rate of recovering the distilled water from the brine;
receiving one or more readings from one or more sensors; and
responsive to the one or more readings, adjusting at least one of the speed of the refrigerant compressor and the speed of the vacuum pump to target the recovery rate.

19. A non-transitory computer-readable medium configured to store code comprising instructions, wherein the instructions, when executed, cause one or more processors to:
cause a refrigerant compressor in a closed-cycle heat pump to compress a refrigerant, the closed-cycle heat pump comprising a hot zone operating at a first temperature range and a cold zone operating at a second temperature range lower than the first temperature range, the refrigerant compressor causing the closed-cycle heat pump to raise the temperature of the hot zone to the first temperature range;
cause an electric vacuum pump to reduce a pressure at a flash tank to reduce a boiling point of brine, the electric vacuum pump in connection with the flash tank, the flash tank in connection with a brine heater and a steam condenser, wherein the brine heater is configured to receive the brine and evaporate the brine to steam and the steam condenser is configured to receive the steam from the brine heater and condense the steam to recover distilled water; and
dynamically adjust operations of the refrigerant compressor and/or the electric vacuum pump.

20. The non-transitory computer-readable medium of claim 19, wherein the instructions, when executed, further cause the one or more processors to:
determine a recovery rate of recovering the distilled water from the brine;
receive one or more readings from one or more sensors; and
responsive to the one or more readings, adjust at least one of the speed of the refrigerant compressor and the speed of the electric vacuum pump to target the recovery rate.
